(19) United States
(12) Patent Application Publication
(10) Pub. No.: US 2026/0287992 A1
(43) Pub. Date: Sep. 24, 2026

(54) PROJECTOR

(71) Applicant: SEIKO EPSON CORPORATION, Tokyo (JP)

(72) Inventor: Hiroyuki OTSUKA, AZUMINO-SHI (JP)

(21) Appl. No.: 19/572,940

(22) Filed: Mar. 20, 2026

(30) Foreign Application Priority Data
Mar. 21, 2025 (JP) 2025-046874

(51) Int. Cl. G03B 21/16; G03B 21/20

(52) U.S. Cl. CPC G03B 21/16; G03B 21/2033

(57) ABSTRACT

A projector includes a plurality of light sources; a temperature detection section and a heat exchanger provided in each of the plurality of light sources; a housing configured to house the plurality of light sources and the heat exchanger; a partition section configured to partition an internal space of the housing into a first cooling flow path and a second cooling flow path; a first cooling device configured to cool the first cooling flow path; a second cooling device configured to cool the second cooling flow path; an integrated circuit element, wherein at least one of the heat exchangers is disposed in each of the first cooling flow path and the second cooling flow path and the integrated circuit element is configured to control drive of each of the first cooling device and the second cooling device according to temperature of the light source detected by the temperature detection section.

The present application is based on, and claims priority from JP Application Serial Number 2025-046874, filed Mar. 21, 2025, the disclosure of which is hereby incorporated by reference herein in its entirety.

### BACKGROUND

### 1. Technical Field

The present disclosure relates to a projector.

### 2. Related Art

In a projector of the related art, a laser diode is used as a light source. JP-A-2006-54329 discloses a projector using solid-state light source chips such as LEDs for each of the RGB colors. JP-A-2006-54329 discloses that the driver circuit includes a temperature compensation circuit for compensating for temperature changes caused by the heat of the solid-state light source chip.

In the case where a plurality of light sources are provided, it is necessary to control the current value for each light source in order to cause each light source to emit light in an appropriate state. JP-A-2006-54329 describes compensating for temperature changes caused by the heat of the solid-state light source chip, but does not mention the temperature sensing of the light source required for current value control. Therefore, there is a demand for a projector capable of controlling the current value appropriately in accordance with the temperature of the light source.

### SUMMARY

To achieve the above objective, one aspect of the present disclosure includes a plurality of light sources; a temperature detection section and a heat exchanger provided in each of the plurality of light sources; a housing configured to house the plurality of light sources and the heat exchangers; a partition section configured to partition an internal space of the housing into a first cooling flow path and a second cooling flow path; a first cooling device configured to cool the first cooling flow path; a second cooling device configured to cool the second cooling flow path; a drive element configured to control drive of the plurality of light sources; and an integrated circuit element that is configured to drive the first cooling device and the second cooling device and that is configured to control the drive element, wherein at least one of the heat exchangers is disposed in each of the first cooling flow path and the second cooling flow path and the integrated circuit element is configured to control drive of each of the first cooling device and the second cooling device according to temperature of the light source detected by the temperature detection section.

### BRIEF DESCRIPTION OF THE DRAWINGS

FIG. 1 is a perspective view of a projector according to a embodiment in a front view.

FIG. 2 is a perspective view of a projector according to the embodiment in a back view.

FIG. 3 is an explanatory diagram illustrating an optical configuration of the projector according to the embodiment.

FIG. 4 is a plan view of a circuit board viewed from a light combining element side.

FIG. 5 is a cross-sectional view taken along line VIV-VIV in FIG. 4.

FIG. 6 is a perspective view of a light guide element viewed from the light combining element side.

FIG. 7 is a diagram illustrating a wiring configuration of the circuit board 110.

FIG. 8 is a block diagram of light source control.

FIG. 9 is a block diagram illustrating a configuration of boards.

FIG. 10 is a perspective view illustrating a state in which a projector main body according to the embodiment is rotated.

FIG. 11 is a perspective view illustrating a lower part of the projector according to the embodiment.

FIG. 12 is a top view illustrating a top surface of the housing with a cover removed.

FIG. 13 is a cross-sectional view taken along line VII-VII in FIG. 6.

FIG. 14 is a diagram illustrating the projector main body from which the housing and the cover are removed.

FIG. 15 is a plan view of a main board as viewed from above in an opposing direction.

FIG. 16 is a perspective view illustrating the auxiliary board.

FIG. 17 is a plan view illustrating the projector main body from which the cover and the main board are removed.

FIG. 18 is a schematic plan view of cooling elements in the first cooling flow path 61 and the second cooling flow path 62.

FIG. 19 is a cross-sectional view taken along line VIII-VIII in FIG. 12.

### DESCRIPTION OF EMBODIMENTS

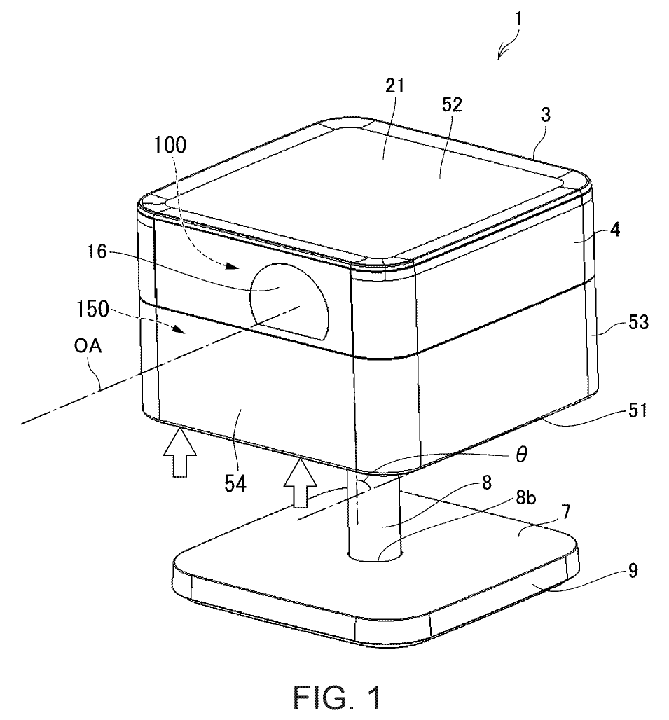

A projector according to a embodiment will be described below with reference to FIGS. 1 to 19.

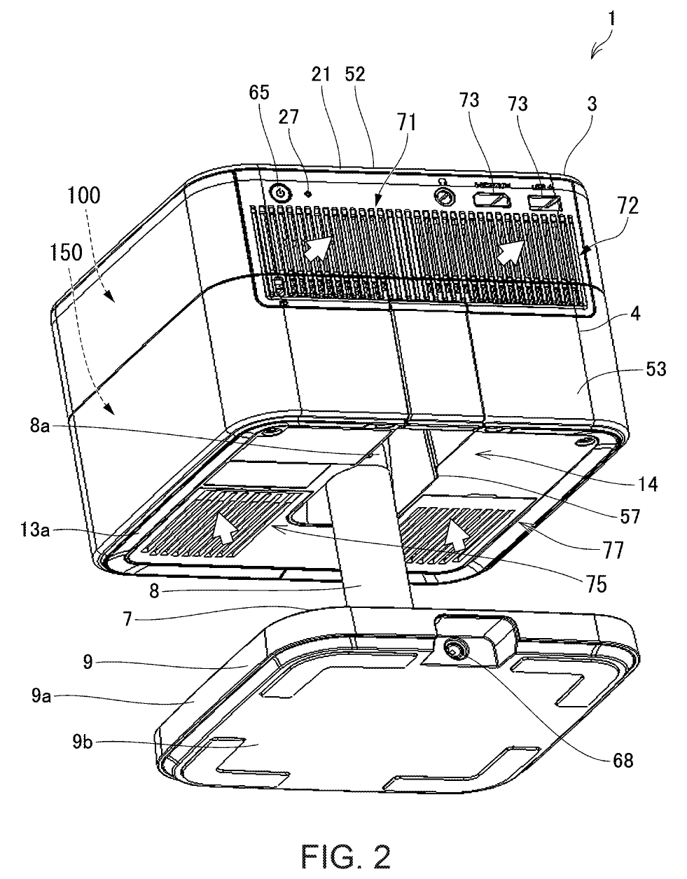

FIG is a perspective view of the projector in a front view. FIG. 2 is a perspective view of the projector 1 in a back view.

### 1. Projector Main Body

A projector 1 is for home use, for example, and is used by being placed on a side table of a bed in a bedroom, for example.

The projector 1 includes a projector main body 3 having a rectangular box shape and a leg section 7 that supports the projector main body 3. The projector main body 3 includes a housing 4 having a substantially rectangular parallelepiped shape, a cover 21 that covers a top surface 52 of the housing 4, and an optical device 100 and an acoustic device 150 housed in the housing 4. The optical device 100 is disposed on the upper side in a height direction in the housing 4. The acoustic device 150 is disposed on the upper side in the height direction in the housing 4. The top surface section of the projector main body 3 has a double structure formed of the top surface 52 of the housing 4 and the cover 21.

As illustrated in FIG. 1, a projection lens 16 for projecting image light is provided on a front surface 54 of the projector main body 3. FIG. 1 illustrates an optical axis OA of the image light projected by the projection lens 16 onto the projection surface. The optical axis OA is a central axis of a projection image, and is, for example, a virtual axis passing through the optical center of the projection lens 16. In FIG. 1, an image projected by the projector main body 3 is projected forward, and the optical axis OA is parallel to an installation surface of the projector 1.

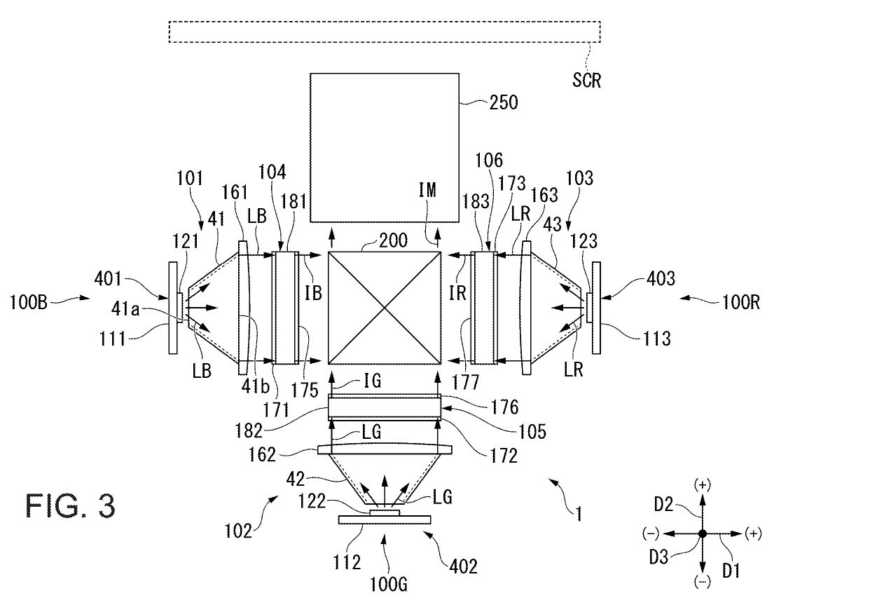

FIG. 3 is an explanatory diagram illustrating an optical configuration of the projector main body 3. The optical configuration is accommodated in the projector main body 3.

The optical device 100 of the projector main body 3 includes a first image forming module 100B, a second image forming module 100G, a third image forming module 100R, a light combining element 200, and a projection optical system 250, as illustrated in FIG. 3.

The first image forming module 100B includes a blue light emitting section 101 and a blue light modulation device 104. The second image forming module 100G includes a green light emitting section 102 and a green light modulation device 105. The third image forming module 100R includes a red light emitting section 103 and a red light modulation device 106.

First, the first image forming module 100B will be described. The blue light emitting section 101 of the first image forming module 100B emits blue light LB. In the following description, a direction parallel to an optical axis of the blue light LB emitted from the blue light emitting section 101 is defined as a D1 direction. Assuming that one side in the D1 direction is a -D1 side, and the opposite side to the -D1 side in the D1 direction is defined as a +D1 side. A direction orthogonal to the D1 direction in a plane including the optical axis of the blue light LB is defined as a D2 direction. Assuming that one side in the D2 direction is a -D2 side, and the opposite side to the -D2 side in the D2 direction is defined as a +D2 side. A direction orthogonal to the D1 direction and the D2 direction is defined as D3 direction. The blue light LB emitted from the blue light emitting section 101 travels toward the +D1 side along the D1 direction.

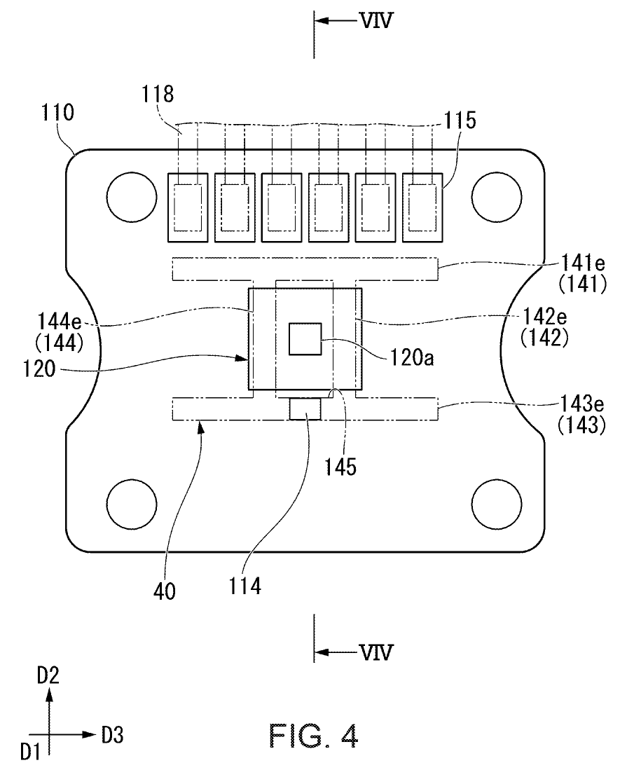

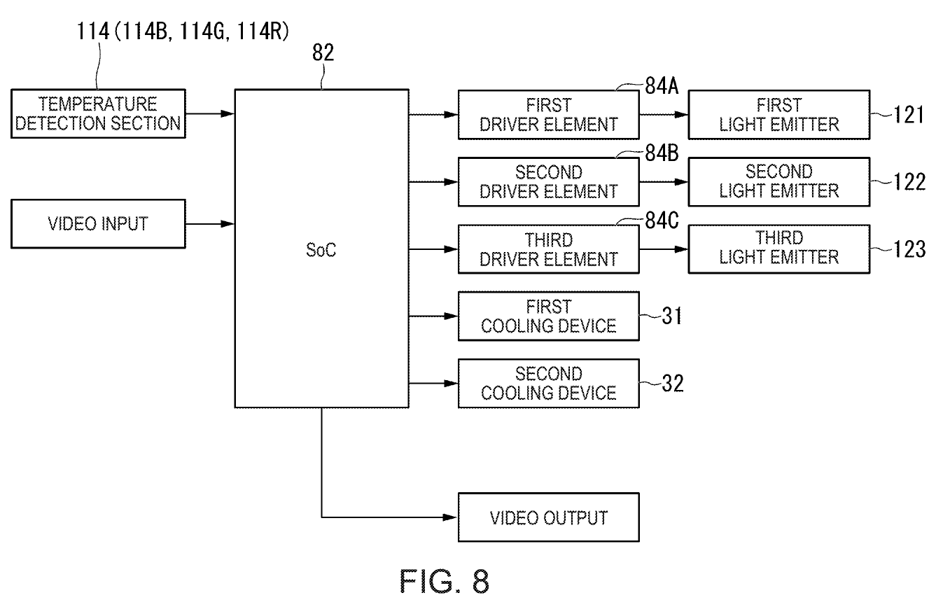

The blue light emitting section 101 has a first light source 401, a first light guide element 41, and a first parallelizing element 161. A first light emitter 121 of the first light source 401 is supported by a first circuit board 111. The first circuit board 111 is a plate including a plane parallel to the D2 direction and the D3 direction. The first circuit board 111 is provided with a temperature detection section 114B (details will be described later) illustrated in FIGS. 4 and 8.

The first light emitter 121 is provided on a plate surface of the first circuit board 111 on the +D1 side.

A light emitting surface of the first light emitter 121 is a surface on the +D1 side, which is the opposite side than the surface provided on the first circuit board 111. The first light emitter 121 emits the blue light LB in a blue wavelength band in the visible wavelength band. The blue wavelength band corresponds to a first wavelength band. The blue light LB corresponds to first light. The blue light LB is emitted toward the +D1 side around the axis passing through the centers of the light emitting surface of the first light emitter 121 and parallel to the D1 direction. The blue wavelength band is, for example, a wavelength band from 420nm to 500nm. The blue wavelength band has the shortest wavelength among the color lights used in the three plate projector, and thus, has high energy.

The first light emitter 121 is formed of, for example, an LED that emits the blue light LB. Note that the first light emitter 121 may be constituted by one LED or may be constituted by all of a plurality of LEDs. In the case where the first light emitter 121 is configured by a plurality of LEDs, the LEDs are arranged in a region occupied by the first light emitter 121 in a plane including the D2 direction and the D3 direction.

The first light guide element 41 is provided in the optical path of the blue light LB emitted from the first light source 401 and is disposed in a position that is on the +D1 side from the first light emitter 121 of the first light source 401 and that overlaps the first light emitter 121 in the D2 direction and the D3 direction. The first light guide element 41 restricts the light guide path for guiding the blue light LB emitted from the first light emitter 121 and causes the blue light LB to propagate toward a first light modulation element 181. The first circuit board 111, the first light guide element 41, and the temperature detection section 114B will be described in detail later.

The first parallelizing element 161 is provided on the optical path of the blue light LB emitted from the first light guide element 41. The first parallelizing element parallelizes the blue light LB emitted from the first light guide element 41 along the D1 direction.

The blue light modulation device 104 has a first incident side polarization element 171, the first light modulation element 181, and a first emission side polarization element 175. The blue light modulation device 104 is provided on the optical path of the blue light LB emitted from the first parallelizing element 161.

The first incident side polarization element 171 is disposed on the +D1 side of the first parallelizing element 161. The first incident side polarization element 171 emits predetermined polarized light of the blue light LB emitted from the first parallelizing element 161 toward the +D1 side along the D1 direction. The first incident side polarization element 171 is, for example, a reflective polarizing plate or an absorptive polarizing plate.

The first light modulation element 181 is disposed on the +D1 side of the first incident side polarization element 171. The first light modulation element 181 modulates the blue light LB emitted from the first incident side polarization element 171. The first light modulation element 181 is, for example, a transmissive liquid crystal panel. The liquid crystal panel constituting the first light modulation element 181 modulates light based on blue image information to generate blue image light IB. The first light modulation element 181 emits the generated image light IB toward the +D1 side along the D1 direction.

The first emission side polarization element 175 is disposed on the +D1 side of the first light modulation element 181. The first emission side polarization element 175 emits predetermined polarized light of the image light IB emitted from the first light modulation element 181 toward the +D1 side along the D1 direction. The first emission side polarization element 175 is, for example, a reflective polarizing plate or an absorptive polarizing plate.

Next, the second image forming module 100G will be described. The green light emitting section 102 of the second image forming module 100G is disposed on the +D1 side and the -D2 side from the blue light emitting section 101, and is disposed in a region overlapping the blue light emitting section 101 in the D3 direction. The green light emitting section 102 emits green light LG. The green light LG emitted from the green light emitting section 102 travels toward the +D2 side along the D2 direction.

The green light emitting section 102 has a second light source 402, a second light guide element 42, and a second parallelizing element 162. A second light emitter 122 of the second light source 402 is supported by a second circuit board 112. The second circuit board 112 is a plate including a plane parallel to the D2 direction and the D3 direction. The second circuit board 112 is provided with a temperature detection section 114G (details will be described later) illustrated in FIGS. 4 and 8.

The second light emitter 122 is provided on a plate surface of the second circuit board 112 on the +D1 side. A light emitting surface of the second light emitter 122 is a surface on the +D1 side, which is the opposite side than the surface provided on the second circuit board 112. The second light emitter 122 emits green light LG in a green wavelength band in the visible wavelength band. The green wavelength band corresponds to a second wavelength band. The green light LG corresponds to second light. The green light LG is emitted toward the +D2 side around the axis passing through the centers of the light emitting surface of the second light emitter 122 and parallel to the D2 direction. The green wavelength band is, for example, a wavelength band from 500nm to 600nm. Since the green wavelength band is easily recognized by the human eye, a large amount of light is required when the green wavelength band is projected on a screen SCR. Similarly to the first light emitter 121, the second light emitter 122 is formed of, for example, an LED that emits the green light LG.

The second light guide element 42 is provided on the optical path of the green light LG emitted from the second light source 402. The second light guide element 42 restricts the light guide path for guiding the green light LG emitted from the second light emitter 122 and causes the green light LG to propagate to a second light modulation element 182. The second circuit board 112, the second light guide element 42, and the temperature detection section 114G will be described in detail later.

The second parallelizing element 162 parallelizes the green light LG emitted from the second light guide element 42 along the D2 direction, as with the first parallelizing element 161.

The green light modulation device 105 has a second incident side polarization element 172, the second light modulation element 182, and a second emission side polarization element 176. The green light modulation device 105 is provided on the optical path of the green light LG emitted from the second parallelizing element 162.

The second incident side polarization element 172 emits predetermined polarized light out of the green light LG emitted from the second parallelizing element 162 toward the +D2 side along the D2 direction, similarly to the first incident side polarization element 171.

The second light modulation element 182 modulates the green light LG emitted from the second incident side polarization element 172, similarly to the first light modulation element 181. The second light modulation element 182 generates green image light IG based on green image information. The second light modulation element 182 emits the image light IG toward the +D2 side along the D2 direction.

The second emission side polarization element 176 emits predetermined polarized light out of the image light IG emitted from the second light modulation element 182 toward the +D2 side along the D2 direction, similarly to the first emission side polarization element 175.

Next, the third image forming module 100R will be described. The red light emitting section 103 of the third image forming module 100R is disposed on the +D1 side from the green light emitting section 102, and is disposed in a region overlapping the blue light emitting section 101 in the D2 direction and the D3 direction. The red light emitting section 103 emits red light LR. The red light LR emitted from the red light emitting section 103 travels toward the -D1 side along the D1 direction.

The red light emitting section 103 has a third light source 403, a third light guide element 43, and a third parallelizing element 163. A third light emitter 123 of the third light source 403 is supported by a third circuit board 113. The third circuit board 113 is a plate including a plane parallel to the D2 direction and the D3 direction. The third circuit board 113 is provided with a temperature detection section 114R (details will be described later) illustrated in FIGS. 4 and 8.

The third light emitter 123 is provided on a plate surface of the third circuit board 113 on the +D1 side.

A light emitting surface of the third light emitter 123 is a surface on the +D1 side, which is the opposite side than the surface provided on the third circuit board 113. The third light emitter 123 emits red light LR in a red wavelength band in the visible wavelength band. The red wavelength band corresponds to a third wavelength band. The red light LR corresponds to third light. The red light LR is emitted toward the -D1 side around the axis passing through the centers of the light emitting surface of the third light emitter 123 and parallel to the D1 direction. The red wavelength band is, for example, a wavelength band from 610nm to 700nm. The third light emitter 123 is formed of, for example, an LED that emits red light LR, similarly to the first light emitter 121 and the second light emitter 122.

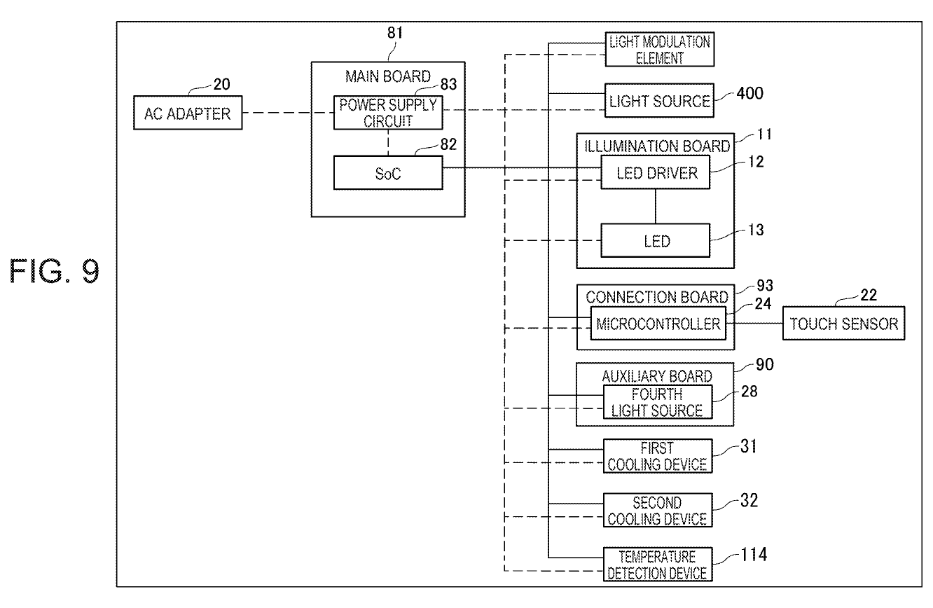

The third light guide element 43 is provided on the optical path of the red light LR emitted from the third light source 403. The third light guide element 43 restricts the light guide path for guiding the red light LR emitted from the third light emitter 123 and causes the red light LR to propagate to a third light modulation element 183. The first light source 401, the second light source 402, and the third light source 403 constitute a light source 400 (see FIG. 9). The third circuit board 113, the third light guide element 43, and the temperature detection section 114R will be described in detail later.

The third parallelizing element 163 parallelizes the red light LR emitted from the third light guide element 43 along the D1 direction, similarly to the first parallelizing element 161 and the second parallelizing element 162.

The red light modulation device 106 has a third incident side polarization element 173, the third light modulation element 183, and a third emission side polarization element 177. The red light modulation device 106 is provided on the optical path of the red light LR emitted from the third parallelizing element 163.

The third incident side polarization element 173 emits predetermined polarized light out of the red light LR emitted from the third parallelizing element 163 toward the -D1 side along the D1 direction, similarly to the first incident side polarization element 171 and second incident side polarization element 172.

The third light modulation element 183 modulates the red light LR emitted from the third incident side polarization element 173, similarly to the first light modulation element 181 and the second light modulation element 182. The third light modulation element 183 generates red image light IR. The third light modulation element 183 emits the image light IR toward the -D1 side along the D1 direction.

The third emission side polarization element 177 emits predetermined polarized light out of the image light IR emitted from the third light modulation element 183 toward the -D1 side along the D1 direction, similarly to the first emission side polarization element 175 and the second emission side polarization element 176.

The light combining element 200 is disposed in a region where the optical path of the blue image light IB, the optical path of the green image light IG, and the optical path of the red image light IR intersect with each other. The light combining element 200 combines the image light IB, IG, and IR emitted from the first emission side polarization element 175, the second emission side polarization element 176, and the third emission side polarization element 177 with one another and emits image light IM thus generated toward the +D2 side along the D2 direction.

The projection optical system 250 is disposed in the optical path of the image light IM emitted from the light combining element 200. The projection optical system 250 projects the image on the screen SCR, and enlarges and displays the image input to the first light modulation element 181, the second light modulation element 182, and the third light modulation element 183 on the screen SCR.

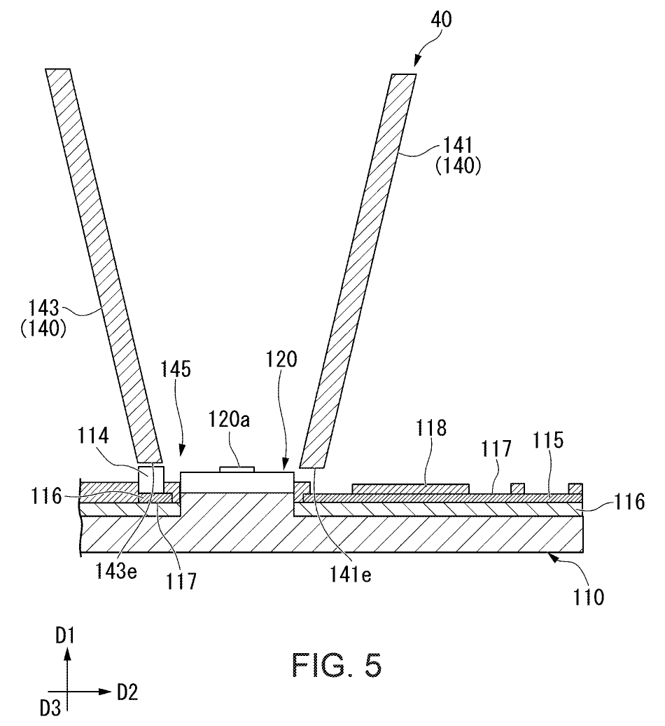

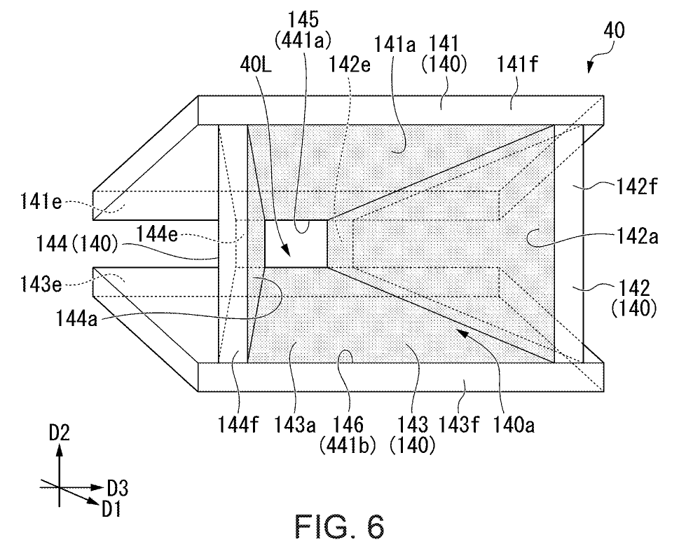

FIG. 4 is a plan view of a circuit board 110 that representatively illustrates the first circuit board 111, the second circuit board 112, and the third circuit board 113, as viewed from the light combining element 200 side. FIG. 5 is a cross-sectional view taken along line VIV-VIV in FIG. 4. FIG. 6 is a perspective view of a light guide element 40 that representatively illustrates the first light guide element 41, the second light guide element 42, and the third light guide element 43, as viewed from the light combining element 200 side. In FIGS. 4 and 5, the temperature detection sections 114B, 114G, and 114R are representatively illustrated as a temperature detection section 114. In FIGS. 4 and 5, the first light emitter 121, the second light emitter 122, and the third light emitter 123 are representatively illustrated as a light emitter 120.

In FIGS. 4 - 6, the description will be made using the D1, D2, D3 coordinate system of the first image forming module 100B.

The circuit board 110 is made of metal, as an example. The circuit board 110 is formed of, for example, copper having high conductivity.

As illustrated in FIG. 4, the circuit board 110 has the light emitter 120 mounted thereon, and includes the temperature detection section 114 and pad sections 115. The light emitter 120 is provided at the center of a plate surface on the +D1 side of the circuit board 110. The light emitter 120 is a rectangular shaped LED chip and has a light emitting section 120a at the center. The light emitting section 120ahas a rectangular shape and emits light of a predetermined color toward the +D1 side along the D1 direction.

The pad sections 115 are copper foil parts (surface mount pad) to which a surface mount component is soldered. The pad sections 115 are provided on the +D2 side of the +D1 side plate surface of the circuit board 110. A plurality of pad sections 115 are disposed along the longitudinal direction (D3 direction) of the +D2 side of the circuit board 110, and in the present embodiment, six pad sections, for example, are disposed. The pad sections 115 have a rectangular shape with a direction along the D3 direction as a longitudinal direction and a direction along the D2 direction as a lateral direction. The arrangement and the number of the pad sections 115 on the circuit board 110 may be changed as appropriate.

The pad section 115 is formed of a conductive foil (for example, a copper foil) 117 provided on the plate surface of the circuit board 110 on the +D1 side via an insulating layer 116. The pad section 115 is disposed at a position where the solder resist 118 is opened on the +D2 side of the circuit board 110.

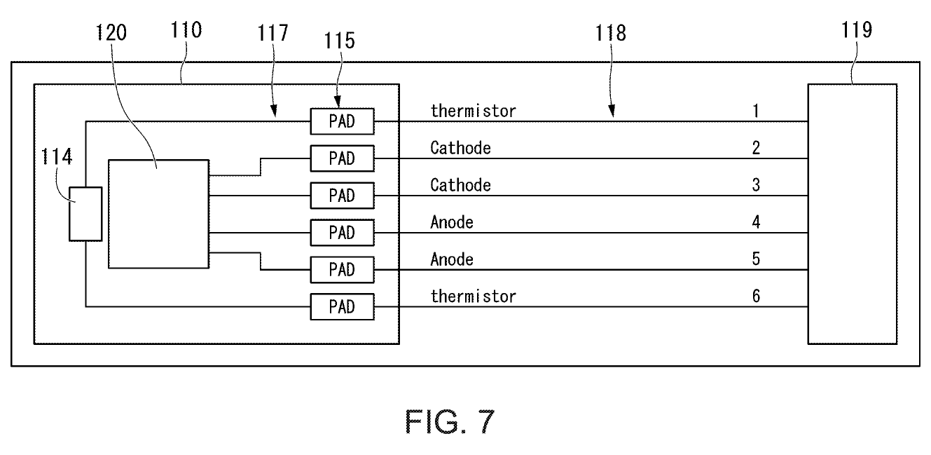

FIG. 7 is a diagram illustrating a wiring configuration of the circuit board 110. As illustrated in FIG. 7, the two pad sections 115 at both ends of the pad sections 115 arranged in the D3 direction are connected to the temperature detection section 114 via conductive foil 117. The four inner pad sections 115 among the pad sections 115 arranged in the D3 direction are connected to the light emitter 120 via the conductive foil 117 connected by wire bonding, for example.

As illustrated in FIG. 9, the light source 400 including the circuit board 110 is electrically connected to a SoC (System on a chip) 82 of the main board 81. The SoC 82 corresponds to an example of an "integrated circuit element". The six pad sections 115 are connected to the SoC 82 via the wirings 118 and the connector 119. Two wirings 118 connected to the light emitter 120 are anodes, and the other two wirings are cathodes.

The temperature detection section 114 is disposed on the circuit board 110 at a position close to the -D2 side of the light emitter 120 on the plate surface on the +D1 side, for example, at a position separated by about the 1 mm. The temperature detection section 114 is disposed at a central position of the light emitter 120 in the D3 direction. The temperature detection section 114 detects the temperature in the vicinity of the light emitter 120. The temperature detection section 114 is, for example, a thermistor. For example, when a thermocouple is used as the temperature detection section 114, noise is likely to occur in the detected temperature due to a change in the temperature of the wirings. By using a thermistor as the temperature detection section 114, it is possible to detect temperature with high accuracy with a small size. The temperature detection section 114 is disposed on the plate surface on the +D1 side of the circuit board 110 similarly to the light emitter 120, and thus the temperature of the light emitter 120 can be accurately detected.

The temperature detection section 114 is disposed on the opposite side of the pad sections 115 with the light emitter 120 interposed therebetween. Since the temperature detection section 114 is disposed on the opposite side of the pad sections 115 with the light emitter 120 interposed therebetween, it is possible to suppress the influence of heat generated in the pad sections 115. The surface position where the temperature detection section 114 is exposed to the +D1 side is flush with a light emitting surface of the light emitting section 120a. Since the surface position of the temperature detection section 114 is flush with the light emitting surface of the light emitting section 120a, the temperature can be detected under the same conditions as those for the light emitting section 120a, and the temperature of the light emitter 120 can be detected more accurately. The temperature detected by the temperature detection section 114 is output to the SoC 82.

The light guide element 40 is provided in an optical path of the light outputted from the light emitter 120 and is disposed on the +D1 side relative to the light emitter 120. The light guide element 40 defines a light guide path for guiding the light emitted from the light emitting section 120a. The light guide element 40 is formed of a plurality of plate members 140. The plurality of plate members 140 include a first member 141, a second member 142, a third member 143, and a fourth member 144.

The first member 141 and the third member 143 are a pair of rectangular shaped plate members. The first member 141 has a first reflective surface 141a on one flat surface. The third member 143 has a third reflective surface 143a on one flat surface. The first member 141 and the third member 143 are plate members having the same shape. The second member 142 and the fourth member 144 are a pair of trapezoidal shaped plate members. The second member 142 has a second reflective surface 142a on one flat surface. The fourth member 144 has a fourth reflective surface 144a on one flat surface. The second member 142 and the fourth member 144 are plate members having the same shape. Hereinafter, when the first reflective surface 141a, the second reflective surface 142a, the third reflective surface 143a, and the fourth reflective surface 144a are not particularly distinguished from each other, these reflective surfaces may be collectively referred to as a reflective surface 140a. The reflective surface 140aconstitutes a light guide path 40L that guides light to the inside of the light guide element 40.

The first reflective surface 141a of the first member 141 and the third reflective surface 143a of the third member 143 are disposed to oppose each other. The second reflective surface 142aof the second member 142 and the fourth reflective surface 144a of the fourth member 144 are disposed to oppose each other. The second member 142 and the fourth member 144 are disposed such that an upper base is positioned on the -D1 side and a lower base is positioned on the +D1 side. One side surface of each of the trapezoidal shaped second member 142 and fourth member 144, which are oblique side portions, are connected to the first reflective surface 141a of the first member 141. The other side surfaces of the second member 142 and the fourth member 144, which are the oblique side portions, are connected to the third reflective surface 143a of the third member 143. The plurality of plate members 140 are bonded to each other by an adhesive. By this, the shape of the light guide element 40 is formed by the plurality of plate members 140.

The first member 141 has a first incident end surface 141e at an end portion on the -D1 side. The second member 142 has a second incident end surface 142eat an end portion on the -D1 side. The third member 143 has a third incident end surface 143eat an end portion on the -D1 side. The fourth member 144 has a fourth incident end surface 144e at an end portion on the -D1 side. A part of the first incident end surface 141e, the second incident end surface 142e, a part of the third incident end surface 143e, and the fourth incident end surface 144e form an incident opening 145. The incident opening 145 forms an incident end 441aon the -D1 side in the light guide path 40L.

The first member 141 has a first emission end surface 141f at an end portion on the +D1 side. The second member 142 has a second emission end surface 142f at an end portion on the +D1 side. The third member 143 has a third emission end surface 143f at an end portion on the +D1 side. The fourth member 144 has a fourth emission end surface 144f at an end portion on the +D1 side. The first emission end surface 141f, the second emission end surface 142f, the third emission end surface 143f, and the fourth emission end surface 144f form an emission opening 146. The emission opening 146 forms an emission end 441b on the +D1 side in the light guide path 40L.

The incident opening 145 extends parallel to a plane that includes the D2 direction and the D3 direction. The incident opening 145 has a rectangular shape as viewed from the D1 direction. The size of the incident opening 145 may be equal to the size of the light emitting section 120a, but is desirably larger than the size of the light emitting section 120a.

As illustrated in FIG. 5, the first incident end surface 141e and the third incident end surface 143e are parallel to a plane including the D2 direction and the D3 direction. When normal plate members are bonded to each other as they are, the corner portions of the first incident end surface 141e and the third incident end surface 143e in the first member 141 and the third member 143 protrude to the -D3 side. The corner portions of the first incident end surface 141e and the third incident end surface 143e are cut off so as to be parallel to the plane including the D2 direction and the D3 direction. Similarly, the second incident end surface 142e and the fourth incident end surface 144e are parallel to the plane including the D2 direction and the D3 direction.

According to this configuration, the gap between the incident opening 145 and the light emitting section 120a in the D3 direction can be reduced. Therefore, the incident opening 145 and the light emitting section 120a can be disposed close to each other in the D3 direction. Therefore, the amount of leakage light generated while traveling from the light emitting section 120a toward the incident opening 145 of the light guide element 40 can be reduced.

As illustrated in FIG. 4, the incident opening 145 of the light guide element 40 is provided to oppose the light emitter 120 of the circuit board 110. The light emitting section 120ais surrounded by a part of the first incident end surface 141e, the second incident end surface 142e, a part of the third incident end surface 143e, and the fourth incident end surface 144e. By this, the light emitted from the light emitting section 120a is guided into the light guide element 40.

The temperature detection section 114 is disposed on the circuit board 110 in a range opposing the third incident end surface 143e of the incident end surface of the light guide element 40. Since the light emitted from the light emitter 120 is guided to the light guide path 40L inside the light guide element 40, the light emitter 120 opposing the light guide element 40 may have a higher temperature than the outside of the range opposing the incident end surface of the light guide element 40. Therefore, when the temperature detection section 114 is disposed outside the range opposing the incident end surface of the light guide element 40, the temperature of the light emitter 120 cannot be accurately detected. In the present embodiment, the temperature detection section 114 is disposed within the range opposing the incident end surface of the light guide element 40, and thus the temperature can be detected with high accuracy according to the temperature rise of the light emitter 120.

FIG. 8 is a block diagram of light source control. As illustrated in FIG. 8, the SoC 82 determines the current value corresponding to the final brightness according to the image input and the ambient temperature of the light emitter 120 detected by the temperature detection section 114. The SoC 82 controls the light amount of the light emitted from the light emitter 120 by PWM control of the current values determined for the light emitter 120. Specifically, the SoC 82 determines the duty ratio, which is the ratio of the current to the rated current in a control period, in accordance with the determined current values, outputs PWM signals having the determined duty ratio to a first driver element 84A, a second driver element 84B, and a third driver element 84C (to be described later), and controls the light amount of the light emitted from the first light emitter 121, the second light emitter 122, and the third light emitter 123.

In the present embodiment, the SoC 82 controls the light amount of the light emitter 120 based on the result of the temperature detection section 114 detecting the temperature of the light emitter 120 (the periphery of the light emitter 120) with high accuracy, and thus the light amount of the light emitter 120 can be controlled with high accuracy.

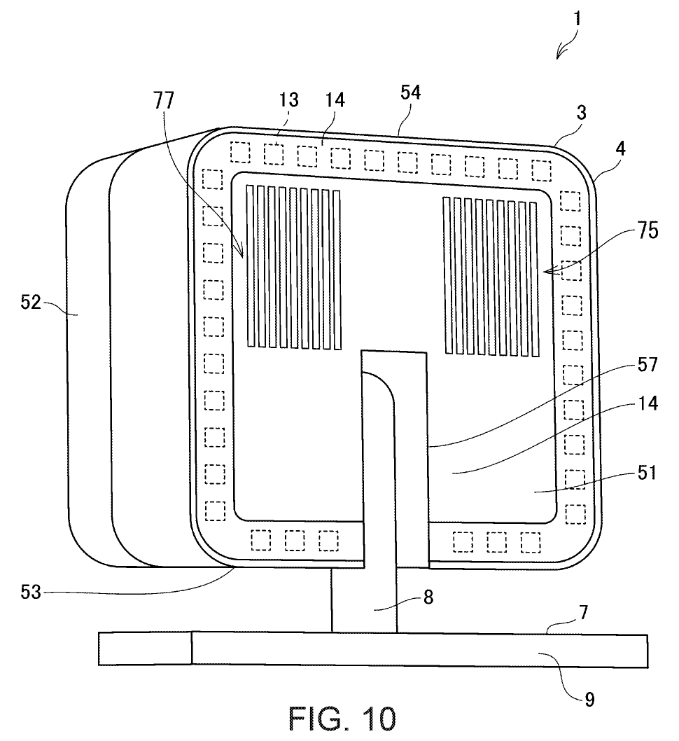

FIG. 10 is a perspective view illustrated a state in which the projector main body 3 is rotated.

The projector main body 3 includes a swing mechanism that rotates the projector main body 3 relative to the leg section 7.

The projector main body 3 is displaceable from the state illustrated in FIG. 2 to the state illustrated in FIG. 10 by the swing mechanism (not illustrated). The position of the displacement of the projector main body 3 by the swing mechanism is desirably two or more positions, and it may be smoothly displaced or may be displaced in a plurality of stages. The displacement may be realized by any one of horizontal rotation, vertical rotation, and three dimensional rotation. The swing mechanism is an example of a "rotation mechanism".

As illustrated in FIGS. 2 and 10, the leg section 7 includes a substantially rectangular shape base 9 and a cylindrical shape support pipe 8 extending upward from the center of the base 9.

A first end section 8a of the support pipe 8 is connected to the projector main body 3, and a second end section 8b is connected to the base 9.

The first end section 8a along a lengthwise axis of the support pipe 8 is inserted into a notch 14, which has a lengthwise axis 57 and which is opened in a bottom surface 51 of the projector main body 3, and is coupled to the bottom surface 51 side of the projector main body 3 via the swing mechanism. A surface where the notch 14 is present is one surface from which the illumination light from a plurality of LEDs 13 is emitted. The "one surface" of the projector main body 3 is a "first surface", that is, the bottom surface 51 of the projector main body 3.

The projector main body 3 is swung in the direction along the lengthwise axis 57 of the notch 14 by the swing mechanism.

The number of the support pipes 8 is not limited to one, and may be two or three. The support pipe 8 may be bent or branched in the middle. The cross section of the support pipe 8 may have various shapes such as a circular shape and a rectangular shape, and the leg section 7 may have, for example, a plate shape.

The shape of the base 9 is not particularly limited, and may be various shapes such as a disc shape. The leg section 7 may be configured only by the support pipe 8 without including the base 9.

### 2. Illumination System

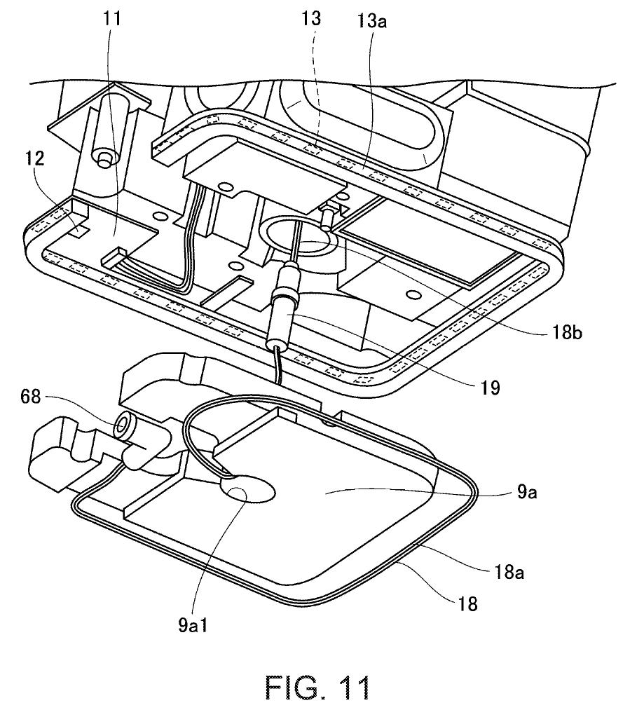

FIG. 11 is a perspective view illustrating a lower portion of the projector 1, and is a diagram in which the housing 4, the cover 21, and a part of the leg section 7 of the projector 1 are omitted.

As illustrated in FIG. 11, a substantially C-shaped illumination board 11 is disposed on the bottom surface 51 of the housing 4 so as to surround the leg section 7.

As illustrated in FIGS. 2 and 10, the illumination board 11 is disposed along the contour of the bottom surface 51. The plurality of LEDs 13 are mounted on the illumination board 11. The plurality of LEDs 13 are covered by an LED cover 13a made of a box-shaped transparent member. The illumination board 11 is provided with an LED driver 12. The plurality of LEDs 13 are controlled by the LED driver 12. The LED driver 12 is an example of a "driver element". Each of the plurality of LEDs 13 is an example of a "second light source." The light from the plurality of LEDs 13 may softly illuminate the periphery of the side table, like a lamp placed on the side table of the bed. Since the projector 1 also functions as an ambient light in this way, the convenience and the effect of the presentation can be improved.

The plurality of LEDs 13 are arranged along the contour of the bottom surface 51, but is interrupted by the opening of the notch 14 formed in the bottom surface 51, so that they are arranged in a substantially C-shape. The shape is not limited to the substantially C-shape, and although not illustrated in the drawings, the plurality of LEDs 13 may extend continuously along the entire periphery of an edge section of the notch 14 and be arranged in a ring shape. Note that it is desirable that at least two of the LEDs 13 among the LEDs 13 are arranged along the contour of the bottom surface 51, and some of the LEDs 13 may be included that are not arranged along the contour. The LEDs 13 may be disposed on the outer peripheral portion of the support pipe 8, or may be disposed on both the bottom surface 51 and the support pipe 8.

The light from the plurality of LEDs 13 are emitted from an emission surface of the bottom surface 51 of the housing 4. The emission surface may be formed at a position recessed from the bottom surface 51, may be formed to be flush with the bottom surface 51, or may protrude from the bottom surface 51 to be formed in a convex shape.

For example, when the emission surface is formed at a recessed position, the plurality of LEDs 13 are not exposed from the bottom surface 51, and thus, the LEDs 13 are protected.

The emission surface in the present embodiment refers to a surface of the LED cover 13a from which light from the LED 13 is emitted.

The emission surface may be flush with the bottom surface 51 or may protrude from the bottom surface 51. When it is disposed flush with the bottom surface 51 of the housing 4, the aesthetic appearance is improved, and damage to the LED 13 is suppressed. In a case where the light source is projected from the bottom surface 51, it is possible to softly illuminate the periphery of the side table more effectively. The plurality of LEDs 13 may be configured to change brightness according to use environments.

The plurality of LEDs 13 are arranged at equal intervals. The distances between two adjacent LEDs 13 among the plurality of LEDs 13 are equal to or larger than the 5 mm and equal to or less than the 30 mm. The distance is a distance in a plan view, and is a distance between the centers of two adjacent LEDs 13. If the distance is less than the 5 mm, there is a risk of thermal influence between the LED 13, and the difficulty of mounting the LED 13 increases. When the distance exceeds the 30 mm, the expressiveness of the presentation of the LED 13 is reduced, and the shadow between the adjacent LEDs 13 becomes more noticeable.

The number of the plurality of LEDs 13 to be mounted is 10 pieces or more and 100 pieces or less, and desirably 20 pieces or more and 50 pieces or less. If there are fewer than 24 pieces, the effect is felt as a lonely impression. When the number of mounted is 24 pieces, the distance is 24 mm.

The number of mounts in LEDs 13 is 36 pieces, and the mounting distance is 16 mm. However, a single LED 13 may be added between the LEDs 13. In this case, the mounting distance of the LEDs 13 is 8 mm. If two are added, the mounting distance will be 5 mm. In this case, the difficulty of mounting is slightly increased, and the arrangement is difficult.

The plurality of LEDs 13 may include the first light emitter that emit light of a first color and the second light emitter that emit light of a second color different from the first color.

The first light emitter is a light emitting diode element that emits light of the first color, and the second light emitter is a light emitting diode element that emits light of the second color.

That is, since each of the "second light sources" includes a light emitting diode element, the degree of freedom of the color and the arrangement of the elements is increased, the degree of freedom of the design can be increased, and the effect of the presentation and the convenience are improved.

The light from the plurality of LEDs 13 may include a plurality of colors. For example, the color may be changed or the light may be blinked according to the state, the setting, or the like at the time of activation of the projector 1. Since the LED 13 is positioned on the bottom surface 51, it serves as indirect ambient light that softly illuminates the entire space, and does not cause glare when projecting with the projector 1.

The LED 13 may be an LED chip or an organic EL panel. The plurality of second light sources may emit light to the outside, and the second light sources may be attached at any position.

For example, the second light source may be provided in the projector main body 3 or may be attached to the surface of the projector main body 3.

### 3. Image and Direction of Illumination Light

The projector main body 3 includes the bottom surface 51 through which illumination light from the plurality of LEDs 13 is emitted, and the front surface 54 through which image light from the projection lens 16 is emitted, as illustrated in FIG. 1.

The image light and the illumination light are emitted from different surfaces of the projector main body 3. In the present embodiment, the image light is emitted from the front surface, and the illumination light is emitted from the bottom surface. An angle θ formed by the front surface 54 and the bottom surface 51 is 90°. That is, the angle θ formed by the direction in which the image light from the projector main body 3 is emitted and the direction in which the illumination light from the plurality of LEDs 13 is emitted is 90°. Therefore, it is possible to prevent the projected image from becoming difficult to see due to the illumination light.

In the above description, the projector main body 3 has a rectangular box shape, but in the case where the projector main body 3 has a cylindrical shape, although not illustrated, the projection lens 16 can be disposed on the front surface side of the projector main body 3, and a plurality of LEDs 13 can be arranged on the back surface side.

In this case, it is desirable that an angle θ formed by the direction in which the image light is emitted and the direction in which the illumination light is emitted is 90° or more.

Here, the direction in which the image light is emitted refers to a direction in which the light travels along the optical axis of the image light.

The direction in which the illumination light is emitted refers to either the direction in which the light travels along the central axis of the entire light, when the entire plurality of LEDs 13 is considered as one illumination light, or the direction in which the light travels along the optical axis of each LED 13.

### 4. Touch Sensor

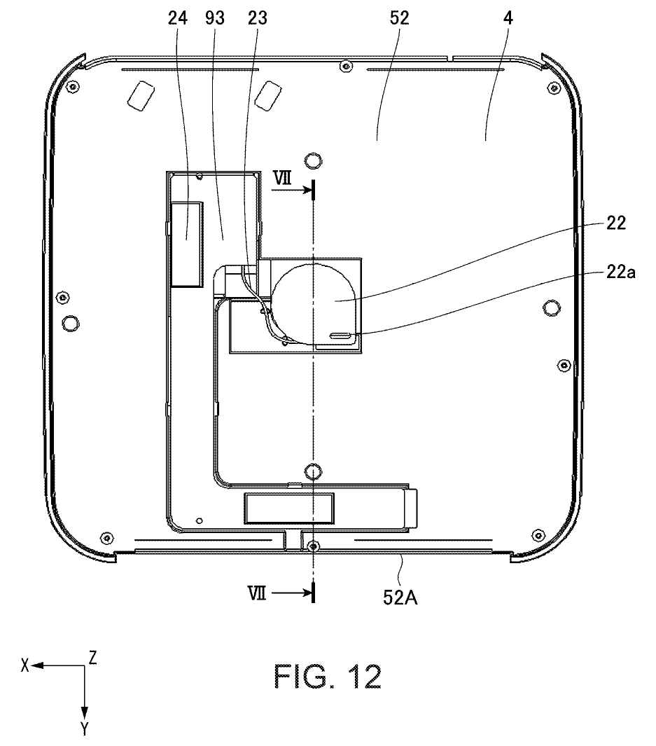

FIG. 12 is a top view illustrating the top surface 52 of the housing 4 with the cover 21 removed.

As illustrated in FIG. 1, the housing 4 includes the top surface 52. The top surface 52 is opposing the bottom surface 51 from which the illumination light of the LED 13 is emitted. As illustrated in FIG. 12, a touch sensor (sensor) 22, which detects the user's contact with the projector main body 3, is disposed between the top surface 52 and the cover 21.

The touch sensor 22 may be a button or a sensor. The cover 21 is provided on the touch sensor 22, and as illustrated in FIG. 12, the touch sensor 22 is disposed on a back surface of the cover 21. Since the touch sensor 22 is hidden by the cover 21, the appearance of the projector 1 can be improved. The touch sensor 22 is an example of a "sensor". Note that when the position of the projector main body 3 is displaced by the swing mechanism, it is desirable that the touch sensor 22 is not disposed on the same surface as the leg section 7.

In the present embodiment, the touch sensor 22 is a copper foil tape. A sensor wiring 23 is attached to an end portion of the touch sensor 22 by soldering. The sensor wiring 23 is connected to a microcontroller 24. An oval shaped opening 22ais formed near a joint section of the touch sensor 22 with the sensor wiring 23. By this, the excessive solder is removed from the opening 22a at the time of soldering. Therefore, the solder does not contaminate the touch sensor 22. By this, prevents the solder from affecting the touch sensor 22, thereby preventing a decrease in sensitivity. The solder is an example of a "conductive bonding material".

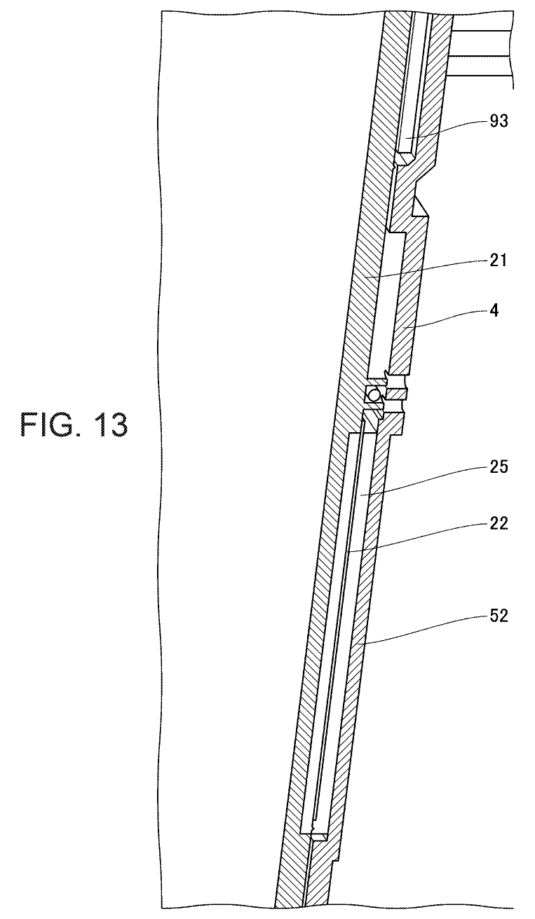

FIG. 13 is a cross-sectional view taken along line VII-VII in FIG. 12.

A spacer 25 is disposed below the touch sensor 22 and, in a state where the cover 21 is attached to the top surface 52, the touch sensor 22 and the spacer 25 are sandwiched between the top surface 52 and the cover 21 as illustrated in FIG. 13. The touch sensor 22 is in a state of being pressed against the back surface of the cover 21 by the spacer 25. Therefore, air is less likely to enter between the touch sensor 22 and the cover 21, and it is possible to prevent the sensitivity of the touch sensor 22 from being lowered by air.

Since the touch sensor 22 is hidden by the cover 21, the aesthetic appearance of the projector 1 is improved. Since the touch sensor 22 is used, the ambient light can be turned on and off without using a remote controller for the ambient light.

When the touch sensor 22 is repeatedly tapped, the ambient light may be turned on and off, the brightness may be decreased, the color of the ambient light may be changed, or the like.

A control section that controls the plurality of LEDs 13 is not limited to the touch sensor 22. For example, another switch, a button, a touch panel, or the like may be used. The control section for turning on the plurality of LEDs 13 is desirably a sensor or the like that is attached to the projector main body 3 and that can be operated by touching the projector main body 3 manually.

As illustrated in FIG. 2, a power button 65 is disposed on a back surface 53 of the projector main body 3. The power button 65 is a button for switching the operation of the projector main body 3 between on and off.

As illustrated in FIG. 2, an indicator 27 that emits light to the outside of the projector main body 3 is disposed on the back surface 53 of the projector main body 3. The indicator 27 is an LED indicator using a fourth light source 28 (see FIG. 9) different from the LED 13, and notifies the state of the optical configuration of the projector main body 3.

Since the indicator 27 is positioned on the opposite side than the projection lens 16, there is an advantage that the user does not need to directly look at the projection light when viewing the indicator 27.

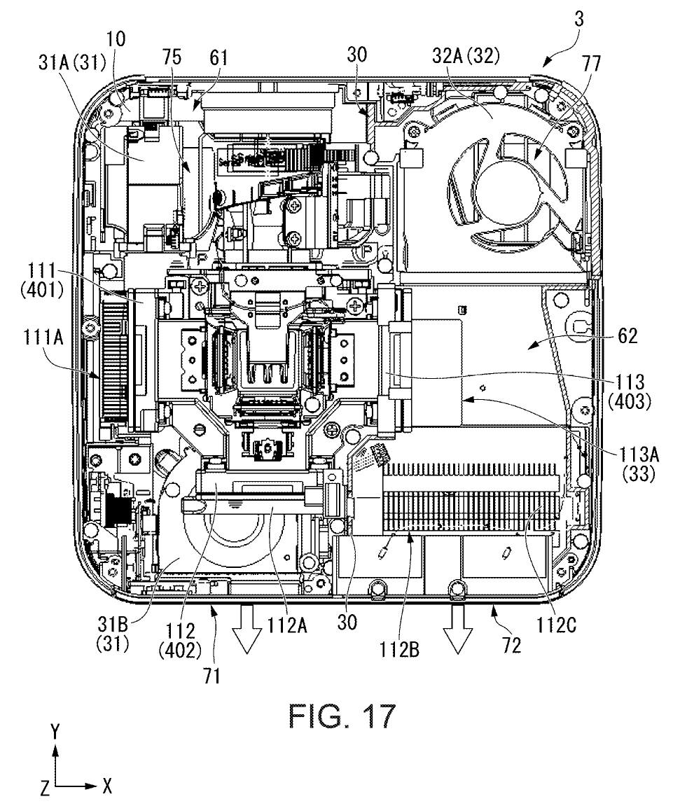

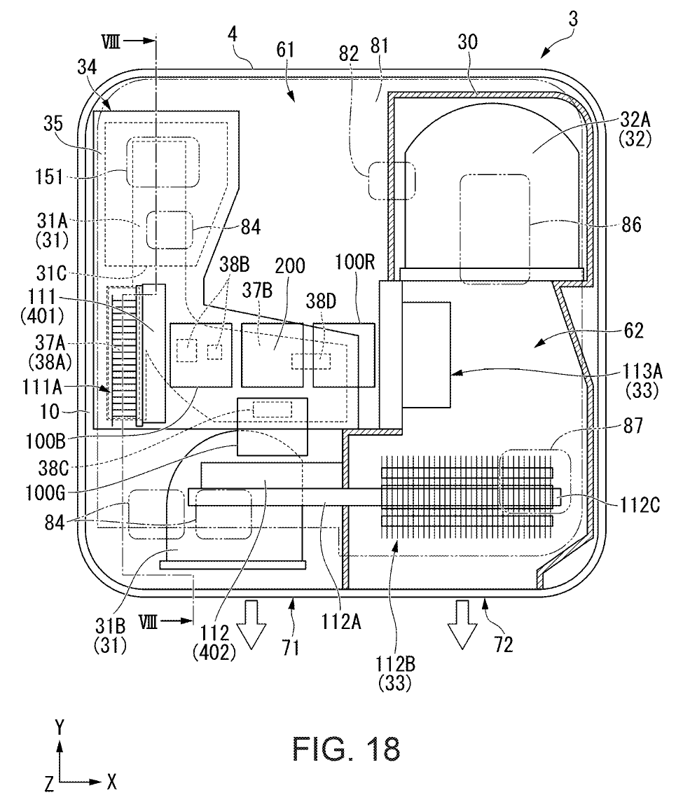

A first air outlet port 71, a second air outlet port 72, and an opening 73 of the video terminal are disposed on the back surface 53 of the projector main body 3. A first air intake port 75 and a second air intake port 77 are disposed side by side on the left and right sides on the bottom surface 51 of the projector main body 3. The side surfaces of the projector main body 3 include the back surface 53 and the front surface 54 other than the bottom surface 51 and the top surface 52. By driving a first cooling device 31 and a second cooling device 32 (see FIGS. 17 and 18) (to be described later), air is sucked into the projector 1 through the first air intake port 75 and the second air intake port 77. The air thus sucked cools the heat generating devices inside the projector 1 and is discharged from the first air outlet port 71 and the second air outlet port 72.

The position of the first air outlet port 71and the second air outlet port 72 is not limited to the back surface 53, and may be the bottom surface 51, the top surface 52, or the side surface of the projector main body 3. Note that it is desirable that the first air outlet port 71 and the second air outlet port 72, and the first air intake port 75 and the second air intake port 77 are not disposed on the same surface so as not to suck the exhausted air again.

It is desirable that the first air outlet port 71 and the second air outlet port 72, and the first air intake port 75 and the second air intake port 77 are not disposed on the same surface as the touch sensor 22. By this, the dust guided along the flow of air can be suppressed from adhering to the touch sensor 22.

The opening 73 for the video terminal illustrated in FIG. 2 is an insertion port of a connection terminal for supplying a video from an external device to the projector main body 3. In the present embodiment, the opening 73 for the video terminal is an opening for a Universal Serial Bus (USB) terminal and a High-Definition Multimedia Interface (registered trademark: HDMI) terminal. Therefore, by connecting the external device and the projector main body 3 to each other via the USB terminal or the HDMI (registered trademark) terminal, the projector main body 3 can project video information from the external device as image light. Note that it is desirable that the opening 73 for the video terminal is not disposed on the same surface as the touch sensor 22.

### 5. Wiring System of Board

As illustrated in FIG. 2, the base 9 has a base case 9a with an open lower surface, and a base cover 9b that covers the lower surface of the base case 9a.

As illustrated in FIG. 11, a round hole 9a1 penetrating in the vertical direction is formed in the base case 9a. The second end section 8bof the support pipe 8 is supported by the round hole 9a1.

As illustrated in FIG. 2, the base 9 includes an AC adapter terminal 68 connected to a power supply. The AC adapter terminal 68 is disposed on the side surface of the base case 9a. An AC adapter 20 (see FIG. 9) is connected to the AC adapter terminal 68. The AC adapter terminal 68 is an example of a "power supply terminal". The AC adapter 20 is an example of a "power supply adapter".

Since the AC adapter terminal 68 is disposed not on the projector main body 3 but on the base 9, a power supply wiring 18 connected to the AC adapter terminal 68 does not interfere with the swinging of the projector main body 3.

As illustrated in FIG. 11, the power supply wiring 18 extends from the AC adapter terminal 68. The power supply wiring 18 is disposed along the outer periphery on the lower surface of the base case 9a, passes through the inside of the support pipe 8 from the round hole 9a1, and is connected to a power supply circuit 83 (see FIG. 9) of a main board 81 (to be described later). In this manner, the power supply wiring 18 is provided with play, and thereby, workability at the time of assembly is facilitated, and damage to the power supply wiring 18 when the projector main body 3 is rotated is suppressed.

The power supply wiring 18 is configured by a first wiring 18a extending from the AC adapter terminal 68 and a second wiring 18b extending from the main board 81. The first wiring 18aand the second wiring 18bare connected by a connector 19 in the support pipe 8. Since the connector 19 is not accommodated inside the projector main body 3, the workability at the time of assembly or the like is improved.

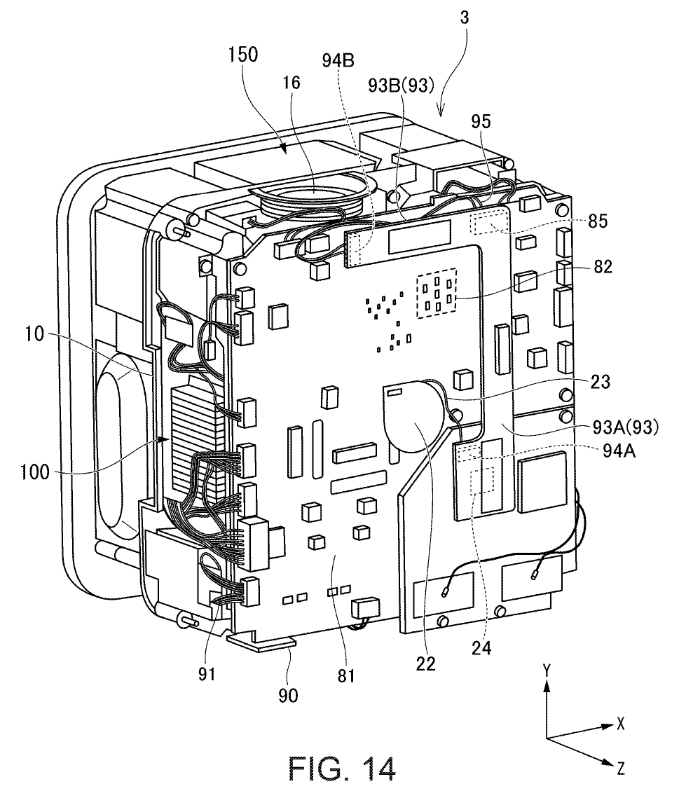

FIG. 14 is a diagram illustrating the projector main body 3 from which the housing 4 and the cover 21 are removed. The projector main body 3 includes the main board 81, a connection board 93, and an auxiliary board 90. The main board 81 of the projector 1 is disposed below the housing 4 and on the top surface 52 of the projector main body 3.

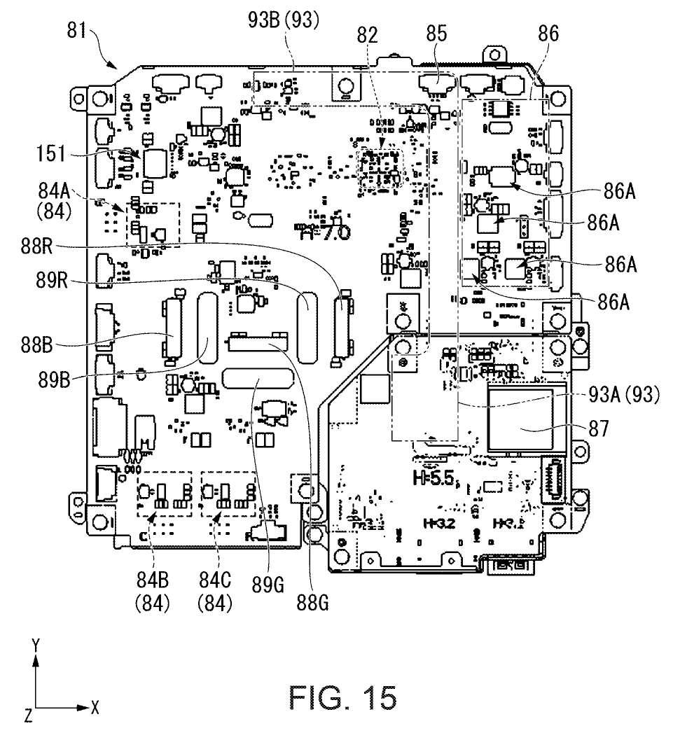

FIG. 15 is a plan view of the main board 81 as viewed from above in the opposing direction that opposes the main board 81. As illustrated in FIGS. 14 and 15, the main board 81 is formed in a substantially rectangular shape. The main board 81 has the SoC 82, a driver element 84 that controls the light source 400, a connector 85, a DC/DC circuit 86 for voltage transformation having a plurality of coils 86A, a communication module 87, and a amplifier element 151.

The driver element 84 has a first driver element 84A that drives the first light source 401, a second driver element 84B that drives the second light source 402, and a third driver element 84C that drives the third light source 403. The amplifier element 151 transmits the amplified signal to the acoustic device 152.

The connector 85 is electrically connected to the SoC 82. The connector 85 is disposed on an outer peripheral portion of the upper surface of the main board 81. The connector 85 is disposed at a position closer to the outer peripheral portion than the touch sensor 22 disposed inside the outer peripheral portion of the main board 81 in plan view (hereinafter simply referred to as "plan view") of the projector main body 3 viewed from above.

Assuming that the vertical direction of the projector main body 3 is a Z direction, a direction in which an outer peripheral portion of the main board 81 on which the connector 85 is disposed extends in plan view is an X direction, and a direction perpendicular to both the Z direction and the X direction is a Y direction. The +Z side is the upper side, and the -Z side is the lower side. The Z direction corresponds to a opposing direction opposing the main board 81. The Y direction corresponds to a first direction. The +Y side corresponds to one side in the first direction. The -Y side corresponds to the other side in the first direction.

The connector 85 is disposed between the SoC 82 and the DC/DC circuit 86 in the X direction. The connector 85, the DC/DC circuit 86, the communication module 87, and the amplifier element 151 are disposed on the surface on the +Z side of the main board 81. The SoC 82 and the driver element 84 are disposed on the surface on the -Z side of the main board 81.

The connection board 93 is formed of, for example, a non-flexible hard material (rigid board). Examples of the hard material include a board obtained by impregnating paper with a phenol resin, a board obtained by impregnating paper with an epoxy resin, a glass composite board, and a glass epoxy board.

As illustrated in FIG. 13, the connection board 93 is disposed between the top surface 52 of the housing 4 and the cover 21. The connection board 93 is a board on which the microcontroller 24 that controls the touch sensor 22 is disposed on the -Z side surface. The connection board 93 is separated from the main board 81 in order to reduce the footprint, and is disposed between the housing 4 and the cover 21 where a space can be secured.

The connection board 93 includes a first portion 93A and a second portion 93B. The first portion 93A extends in the Y-direction. The position of the first portion 93A in the X direction is a position overlapping the connector 85 in plan view. The first portion 93A has a connection connector 94A on a surface opposing the main board 81 on the -Y side, which is one end side. The connection connector 94A is electrically connected to the microcontroller 24. The connection connector 94A is connected to the sensor wiring 23. The microcontroller 24 is electrically connected to the touch sensor 22 via the sensor wiring 23.

The first portion 93A linearly extends from the -Y side to the +Y side toward the connector 85. The first portion 93A is disposed separated from the electromagnetic interference object described above in plan view. The first portion 93A is disposed at a position and with a size so as to not overlap the electromagnetic interference object in plan view. As an example, the first portion 93A is disposed at a position and with a size so as to not overlap the SoC 82 described above, the DC/DC circuit 86, and the communication module 87 in plan view. The first portion 93A may extend in a zigzag shape or a curved shape in a path that circumvents the electromagnetic interference object described above in plan view, in addition to a straight line shape, as long as the first portion 93A does not overlap the electromagnetic interference object in plan view.

Since the connection board 93 is a rigid board, bending is suppressed, and thus, it is possible to suppress deterioration of the EMI characteristics due to contact with the electromagnetic interference object. Since the first portion 93A is disposed separated from the electromagnetic interference object and does not overlap the electromagnetic interference object in plan view, it is possible to suppress the occurrence of noise due to deterioration of the EMI characteristics caused by electromagnetic interference with the electromagnetic interference object.

The second portion 93B extends from a tip end of the first portion 93A in a direction separated from the connector 85 along the outer peripheral portion of the main board 81 in plan view. The connector 85 opposes the intersection of the first portion 93A and the second portion 93B in the Z direction. The second portion 93B linearly extends from the tip end of the first portion 93A toward the -X side. The second portion 93B is disposed separated from the electromagnetic interference object described above in plan view. The second portion 93B is disposed at a position and with a size so as not to overlap the electromagnetic interference object in plan view. As an example, the second portion 93B is disposed at a position and with a size so as not to overlap the SoC 82 in plan view. The second portion 93B may extend from the tip end of the first portion 93A in a zigzag shape or curved shape path that circumvents the electromagnetic interference object described above in plan view, in addition to extending linearly, as long as the second portion 93B does not overlap the electromagnetic interference object in plan view.

Since the second portion 93B is disposed separated from the electromagnetic interference object and does not overlap the electromagnetic interference object in plan view, it is possible to suppress the occurrence of noise due to deterioration of the EMI characteristics caused by electromagnetic interference with the electromagnetic interference object.

The second portion 93B has a second connector 94B at a tip end on the -X side. The second connector 94B is electrically connected to the microcontroller 24. The second connector 94B is connected to a connection cable 95. The connection cable 95 is drawn out from the second connector 94B to the -X side, is then drawn around to the +X side, and is connected to the connector 85 across the top surface 52 in the Z direction via a notch 52A formed at an end edge of the top surface 52 on the +Y side as illustrated in FIG. 12. Therefore, the microcontroller 24 is electrically connected to the SoC 82 via the connection cable 95 and the connector 85. The SoC 82 inputs a detection result of the touch sensor 22 via the microcontroller 24 and the connection cable 95.

Since the distance between the connection board 93 and the main board 81 in the Z direction is several cm, for example, in a case where the second connector 94B is provided at a tip end of the first portion 93A on the +Y side without providing the second portion 93B in the connection board 93, the distance between the connector 85 and the second connector 94B is short. In this case, considering the lengths of the terminals at both ends of the connection cable 95, the movable range of the connection cable 95 becomes short, and the work of attaching the connection cable 95 to the connector 85 and the second connector 94B becomes difficult.

In the present embodiment, the connection board 93 has the second portion 93B, and the second connector 94B is intentionally provided at a position separated from the connector 85, and thus, the distance between the connector 85 and the second connector 94B and the length of the connection cable 95 are increased, and the movable range of the connection cable 95 is increased, and thus, the work of mounting the connection cable 95 on the connector 85 and the second connector 94B is facilitated.

Since the connection cable 95 is connected to the connector 85 across the top surface 52 in the Z direction via the notch 52A on the +Y side, for example, compared to a case where the connection cable 95 is inserted into a hole section formed inside the end edge of the top surface 52 and connected to the connector 85, the work of connecting the connection cable 95 to the connector 85 from the +Y side is facilitated.

The main board 81 has a first light source connector 88B, a second light source connector 88G, and a third light source connector 88R electrically connected to the first light source 401, the second light source 402, and the third light source 403, respectively, and an opening section 89B, an opening section 89G, and an opening section 89R through which light source wirings (not illustrated) electrically connected to the first light source connector 88B, the second light source connector 88G, and the third light source connector 88R, respectively, are inserted. The connection board 93 is disposed apart from the opening section 89B, the opening section 89G, and the opening section 89R in plan view, and the connection board 93 is disposed separated from the opening section 89B, the opening section 89G, and the opening section 89R in plan view, and thus, it is possible to suppress an adverse effect of static charge due to the light source wiring.

As illustrated in FIG. 14, the auxiliary board 90 on which the fourth light source 28 is mounted is disposed on the back surface 53 of the projector main body 3 and substantially perpendicular to the main board 81. The auxiliary board 90 is connected to the main board 81 by an auxiliary wiring 91.

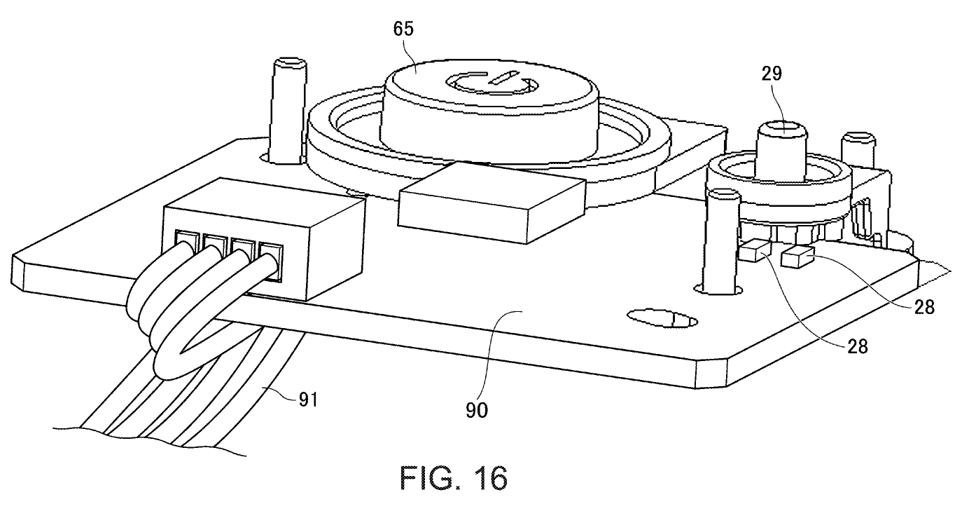

FIG. 16 is a perspective view of the auxiliary board 90.

The power button 65 and the fourth light source 28 are mounted on the auxiliary board 90. In the present embodiment, the fourth light source 28 is an LED. The fourth light source 28 is disposed so that a lens 29 covers it in the direction of irradiation. A part of the outer end of the lens 29 is exposed to the exterior of the housing 4, and light is emitted to the outside of the projector main body 3 via the lens 29 by the lighting of the fourth light source 28, and functions as the indicator 27 as illustrated in FIG. 2. In the present embodiment, two fourth light sources 28 are mounted, and the emission colors thereof are different from each other. The lighting pattern of the fourth light source 28 allows the user to recognize the state of the projector 1.

In the present embodiment, the microcontroller 24 performs only the detection of the touch sensor 22, receives output information of the touch sensor 22 via the sensor wiring 23 connected to the touch sensor 22, and performs processing according to the output. Since the microcontroller 24 performs only the detection of the touch sensor 22, it is possible to prevent the detection from being missed. The sensor wiring 23 is an example of "wiring for transmitting an output of the touch sensor".

FIG. 17 is a plan view illustrating the projector main body 3 from which the cover 21 and the main board 81 are removed. The projector main body 3 includes a partition section 30, the first cooling device 31, the second cooling device 32, and a heat exchanger 33. The partition section 30 partitions an internal space of the housing 4 into a first cooling flow path 61 positioned on the -X side and a second cooling flow path 62 positioned on the +X side. The first cooling flow path 61 and the second cooling flow path 62 each extend in the Y direction. The first cooling flow path 61 and the second cooling flow path 62 are formed on the upper side of a support board 10 (see FIG. 14) that supports the optical device 100 from the lower side.

FIG. 18 is a schematic plan view of cooling elements in the first cooling flow path 61 and the second cooling flow path 62. In FIG. 18, the main board 81 and the elements mounted on the main board 81 are indicated by two-dot chain lines. In FIG. 18, the partition section 30 is illustrated with hatching.

The partition section 30 prevents the air blown from a first fan 31A to the first cooling flow path 61 from flowing into the second cooling flow path 62. The partition section 30 prevents the air blown from the first fan 31A to the first cooling flow path 61 from flowing into the second cooling flow path 62 at least on the -Y side of an air blowing port through which a third fan 32A blows air into the second cooling flow path 62. In the partition section 30, a region in which the third fan 32A opposes the second air intake port 77 and air is sucked from the second air intake port 77 may be open on the +Y side of the air blowing port of the third fan 32A.

The partition section 30 is formed of a substantially cylindrical shaped duct extending in the Y direction. The partition section 30 forms a second cooling flow path 62 in the duct. The duct opens to the -Z side at the end portion on the +Y side. The opening of the duct opposes the second air intake port 77. The duct covers the internal space of the housing 4 on the -Y side of the air blowing port of the third fan 32A that blows air to the second cooling flow path 62, thereby forming the second cooling flow path 62 separated from the first cooling flow path 61. In the internal space of the housing 4, a region that is not surrounded by the duct on the upper side of the support board 10 is a first cooling flow path 61.

The first cooling device 31 cools the first cooling flow path 61. The first cooling device 31 has the first fan 31A disposed on the +Y side of the first cooling flow path 61 and a second fan 31B disposed on the -Y side of the first cooling flow path 61. The first cooling device 31 having the first fan 31A and the second fan 31B is controlled to be driven by the SoC 82 as illustrated in FIG. 9.

The second fan 31B is disposed to oppose the +Y side of the first air outlet port 71. The first fan 31A is, for example, a centrifugal fan that rotates around a rotation axis extending in the X direction. The first fan 31A blows the air sucked through the first air intake port 75 to the first cooling flow path 61. The second fan 31B is, for example, a centrifugal fan that rotates around a rotation axis extending in the Z direction. The second fan 31B blows the sucked air to the -Y side and exhausts the air from the first air outlet port 71.

The second cooling device 32 cools the second cooling flow path 62. The second cooling device 32 has third fan 32A disposed on the +Y side of the second cooling flow path 62. The second cooling device 32 having the third fan 32A is controlled to be driven by the SoC 82 as illustrated in FIG. 9. The third fan 32A is, for example, a centrifugal fan that rotates around a rotation axis extending in the Z direction. The third fan 32A blows the air sucked from the second air intake port 77 through the opening of the duct to the -Y side and exhausts the air from the second air outlet port 72. The intake air flow amount of the third fan 32A is larger than the intake air flow amount of the first fan 31A.

The first light source 401, the second light source 402, the third light source 403, and the main board 81 are disposed in the first cooling flow path 61. That is, the SoC 82, the driver element 84, the DC/DC circuit 86, and the communication module 87, which are disposed on the main board 81 and generate a large amount of heat, are disposed in the first cooling flow path 61.

The heat exchanger 33 conducts heat from an object having a high temperature to an object having a low temperature. The heat exchanger 33 includes first heat exchangers 111A provided in the first light source 401, second heat exchangers 112B provided in the second light source 402, and third heat exchangers 113A provided in the third light source 403. The first heat exchangers 111A, the second heat exchangers 112B, and the third heat exchangers 113A are exemplified by cooling fins that transfer heat to air having a low temperature. The heat of the first light source 401, the second light source 402, and the third light source 403 is transferred (heat exchange) to the air via the cooling fins. The heat of the first light source 401, the second light source 402, and the third light source 403 is transferred to the air, so that the first light source 401, the second light source 402, and the third light source 403 are cooled.

The first circuit board 111 supporting the first light emitter 121 of the first light source 401 is provided with the first heat exchangers 111A. The first heat exchangers 111A are made of a plurality of metallic plate materials that are parallel to an XZ plane and extend in the Z direction, and are provided with gaps in the Y direction. The first heat exchangers 111A are disposed in the first cooling flow path 61.

The second circuit board 112 supporting the second light emitter 122 of the second light source 402 is provided with a heat pipe 112A and the second heat exchangers 112B. The heat pipe 112A has a shaft shape extending in the X direction. The heat pipe 112A is provided in contact with the -Y side end portion of the second circuit board 112 from the -Y side via grease. The heat pipe 112A extends from the first cooling flow path 61 to the second cooling flow path 62 through the partition section 30. The second heat exchangers 112B are made of a plurality of metallic plate materials that are parallel to a YZ plane and extend in the Z direction, and are provide with gaps in the X direction. The plurality of second heat exchangers 112B are connected by a cylinder section 112C extending in the X direction. The second heat exchangers 112B are disposed in the second cooling flow path 62. The heat pipe 112A is inserted into the cylinder section 112C from the -X side and in contact with it. That is, the heat pipe 112A is disposed across the first cooling flow path 61 and the second cooling flow path 62, and is in contact with the second light source 402 and the second heat exchangers 112B.

The +Y side end portions of the second heat exchangers 112B are positioned on the +Y side of the -Y side end portion of the second circuit board 112 as viewed from the height direction of the housing 4. Since the end portion on the + Y side of the second heat exchangers 112B are positioned on the +Y side of the end portion on the -Y side of the second circuit board 112, the second heat exchangers 112B can be disposed on the +Y side compared to the case where the second heat exchangers 112B are disposed in contact with the -Y side of the second circuit board 112, and the projector main body 3 can be reduced in size in the Y direction.

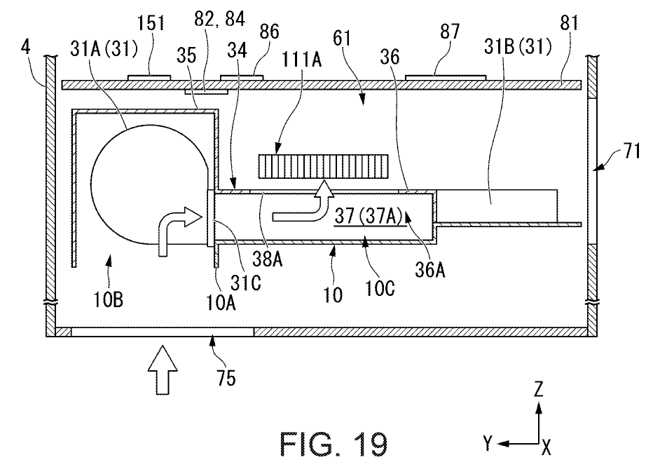

FIG. 19 is a cross-sectional view taken along line VIII-VIII in FIG. 18.

As illustrated in FIG. 19, in the first cooling flow path 61, a branch duct 34 is provided on the air blowing port 31C of the first fan 31A. The branch duct 34 is fixed to the support board 10 from above. The branch duct 34 has a fan case 35 and a flow path forming section 36. The fan case 35 has a cylindrical shape extending in the Z direction, and has a closed upper side and an open lower side. The fan case 35 accommodates the first fan 31A. The fan case 35 forms an opening 10B between the fan case 35 and a wall section 10A extending downward from the end portion of the support board 10 on the +Y side. The opening 10B opposes the first air intake port 75 in the Z direction.

The flow path forming section 36 has a recess section 36A that is recessed upward and opens downward. The support board 10 has a recess section 10C extending from the air blowing port 31C to the -Y side. The recess section 10C is recessed downward and opens upward. The recess section 36A and the recess section 10C oppose each other in the Z direction and form a plurality of branch paths 37 extending to the -Y side. As illustrated in FIG. 18, the branch paths 37 include a first branch path 37A and a second branch path 37B. Although an example in which the number of branch paths 37 is two is illustrated, the number may be three or more.

The branch paths 37 branch the air from the air blowing port 31C and guide the air to a predetermined position of the first cooling flow path 61. The branch paths 37 have opening sections that open at predetermined positions of the first cooling flow path 61. The first branch path 37A has an opening section 38A that extends to a lower side of the first heat exchangers 111A at a predetermined position and opposes the first heat exchangers 111A in the Z direction.

The second branch path 37B extends to, as an example, a position overlapping the first image forming module 100B, the second image forming module 100G, the third image forming module 100R, and the light combining element 200 among the optical device 100 as viewed from the upper side. The second branch path 37B has the first image forming module 100B, the second image forming module 100G, the third image forming module 100R, and opening sections 38B, 38C, and 38D opposing the light combining element 200 in the direction Z. The opening section 38B is open at a position opposing the first image forming module 100B in the Z direction. The opening section 38C is open at a position opposing the second image forming module 100G in the Z direction. The opening section 38D is open at a position opposing the third image forming module 100R and the light combining element 200 in the direction Z.

Among the air sucked by the first fan 31A through the first air intake port 75 and blown to the branch paths 37, the air blown from the opening section 38A through the first branch path 37A passes through the first heat exchangers 111A, cools the first heat exchangers 111A by heat exchange, and is then blown upward to the first cooling flow path 61.

Among the air sucked by the first fan 31A through the first air intake port 75 and blown to the branch paths 37, the air blown from the opening section 38B through the second branch path 37B is blown upward toward the first image forming module 100B, cools the first image forming module 100B by heat exchange, and then is blown toward the main board 81. The air blown from the opening section 38C through the second branch path 37B is blown upward toward the second image forming module 100G, cools the second image forming module 100G by heat exchange, and then is blown toward the main board 81. The air blown from the opening section 38D through the second branch path 37B is blown upward toward the third image forming module 100R, cools the third image forming module 100R and the light combining element 200 by heat exchange, and is then blown toward the main board 81.

The air blown toward the main board 81 flows along the lower surface of the main board 81, thereby cooling the main board 81 including the SoC 82, the driver element 84, the DC/DC circuit 86, the communication module 87, and the amplifier element 151 by heat exchange. Therefore, the first light source 401, the second light source 402, the third light source 403, the SoC 82, the driver element 84, the DC/DC circuit 86, the communication module 87, and the amplifier element 151, which are disposed in the first cooling flow path 61, are cooled by heat exchange with air. By sending the air sucked by the first fan 31A to the branch paths 37 and sending the air sucked by the second fan 31B to the -Y side to be exhausted from the first air outlet port 71, a flow of air from the +Y side to the -Y side is generated in the first cooling flow path 61 as a whole, and the first light source 401, the second light source 402, the third light source 403, the SoC 82, the driver element 84, the communication module 87, and the amplifier element 151 are cooled by heat exchange with the air.

Here, since the SoC 82 and the amplifier element 151 are disposed at a position closer to the first fan 31A than to the second fan 31B as viewed from the upper side, they are heat exchanged with air having a smaller temperature rise than air on the downstream side (-Y side) having a larger temperature rise as a whole due to heat exchange, and thus can be effectively cooled.

Third heat exchangers 113A and the second heat exchangers 112B are disposed in the second cooling flow path 62. The third heat exchangers 113A are provided on the third circuit board 113 that support the third light emitter 123 of the third light source 403. The third heat exchangers 113A are made of a plurality of metallic plate members that are parallel to an XY plane and extend in the Y direction, and are provide with gaps in the Z direction. The third heat exchangers 113A are disposed at a position closer to the third fan 32A on the +Y side than the second heat exchangers 112B.

The third light emitter 123 that emits red light has lower resistance to heat than the light emitters that emit light of other colors. By disposing the third heat exchangers 113A at a position closer to the third fan 32A than the second heat exchangers 112B, the third light emitter 123 can be cooled via the third heat exchangers 113A by the air that is before the temperature thereof rises due to heat exchange with the second heat exchangers 112B. Therefore, the life of the third light emitter 123 can be extended.

The air sucked by the third fan 32A through the second air intake port 77 is blown to the -Y side of the second cooling flow path 62 through the opening of the duct of the partition section 30. The third heat exchangers 113A and the second heat exchangers 112B are sequentially cooled by the air blown into the second cooling flow path 62. The air whose temperature has been raised by the heat exchange is exhausted from the second air outlet port 72.

As the third heat exchangers 113A are cooled, the third light source 403 are cooled via the third circuit board 113. When the second heat exchangers 112B is cooled and the heat pipe 112A is in contact with the second circuit board 112 and the temperature of the heat pipe 112A rises, thereby the working fluid in of the heat pipe 112A evaporates on the side in contact with the second circuit board 112 to become gas, and absorbs heat as latent heat and releases the heat to the second heat exchangers 112B to return to liquid, so that the second light source 402 are cooled via the second circuit board 112. That is, the second light source 402 is directly cooled by heat exchange with the air flowing through the first cooling flow path 61, and the second heat exchangers 112B are indirectly cooled via the heat pipe 112A by heat exchange with the air flowing through the second cooling flow path 62.

In the present embodiment, the amount of heat released to the second cooling flow path 62 is larger than the amount of heat released to the first cooling flow path 61. Specifically, the amount of heat released from the heat exchangers 113A and the second heat exchangers 112B in the second cooling flow path 62 is larger than the amount of heat released from the first light source 401, second light source 402, and third light source 403, the SoC 82, and the main board 81 including the driver element 84, the DC/DC circuit 86, the communication module 87, and the amplifier element 151 in the first cooling flow path 61.

In other words, the power consumption P (W) in the above described members, circuits, and elements correlates with the amount of heat generated and is obtained by multiplying the voltage V by the current I. Therefore, the sum of the power consumption P of the heat generation sources in the second cooling flow path 62 is larger than the sum of the power consumption P of the heat generation sources in the first cooling flow path 61.

In the present embodiment, the cooling capacity of the second cooling device 32 is higher than the cooling capacity of the first cooling device 31. The cooling capacity is correlated with, for example, the air volume, the static pressure, and the rotation speed. Therefore, by making the cooling capacity of the third fan 32A higher than the sum of the cooling capacity of the first fan 31A and the second fan 31B, it is possible to effectively cool the projector main body 3 having the plurality of light sources 400.

FIG. 9 is a block diagram illustrated a configuration of each of the boards 11, 81, 90, and 93. In FIG. 9, solid lines indicate signal input/output relationships and chain lines indicate electrical connection relationships. The main board 81 is connected to the illumination board 11, the auxiliary board 90, and the connection board 93. The SoC 82 disposed on the main board 81 is connected to the LED driver 12 and controls the LEDs 13 mounted on the illumination board 11 via the LED driver 12.

As described above, the SoC 82 determines the current value corresponding to the final brightness based on the results of the temperature detection section 114 detecting the temperatures around the first light emitter 121, the second light emitter 122, and the third light emitter 123. The SoC 82 controls the first cooling device 31 and the second cooling device 32 to drive the first fan 31A, the second fan 31B, and the third fan 32A, while controlling the light amount of the light emitted from the light emitter 120 by PWM control of the determined current value to the first light emitter 121, the second light emitter 122, and the third light emitter 123 via the first driver element 84A, the second driver element 84B, and the third driver element 84C.

When the temperature detected by the temperature detection section 114 exceeds a predetermined range, the SoC 82 increases the driving force of at least one of the first cooling device 31 and the second cooling device 32 according to the position of the heat exchanger 33 provided in the light source 400 detected by the temperature detection section 114. For example, when the temperature of the first light emitter 121 detected by the temperature detection section 114B exceeds a predetermined range, the SoC 82 increases the air blowing amounts of the first fan 31A and the second fan 31B of the first cooling flow path 61 in which the first heat exchangers 111A are disposed, in order to cool the first light source 401 including the first light emitter 121.

For example, when the temperature of the third light emitter 123 detected by the temperature detection section 114R exceeds a predetermined range, the SoC 82 increases the air blowing amount of the third fan 32A of the second cooling flow path 62 in which the third heat exchangers 113A are disposed, in order to cool the third light source 403 including the third light emitter 123. When the temperature of the third light emitter 123 does not fall within the predetermined range even if the air blowing amount of the third fan 32A is increased, the SoC 82 also increases the air blowing amounts of the first fan 31A and the second fan 31B of the first cooling flow path 61 in which the third light source 403 is disposed.

Similarly, when the temperature of the second light emitter 122 detected by the temperature detection section 114G exceeds a predetermined range, the SoC 82 increases the air blowing amount of the third fan 32A of the second cooling flow path 62 in which the second heat exchangers 112B are disposed, in order to cool the second light source 402 including the second light emitter 122. When the temperature of the second light emitter 122 does not fall within the predetermined range even if the air blowing amount of the third fan 32A is increased, the SoC 82 also increases the air blowing amounts of the first fan 31A and the second fan 31B of the first cooling flow path 61 in which the second light source 402 is disposed.

As described above, when the temperature detected by the temperature detection section 114 does not fall within the predetermined range even if the air blowing amounts of all of the first fan 31A, the second fan 31B, and the third fan 32A are increased, the SoC 82 controls the drive of the driver element 84 together with the drive of the first cooling device 31 and the second cooling device 32, determines the current value corresponding to the final brightness based on the temperature detected by the temperature detection section 114, and can appropriately control the light amount of the light emitted from the light emitter 120 by the PWM control.

As described above, in the projector 1 according to the present embodiment, the drive of the first cooling device 31 and the second cooling device 32 is controlled in accordance with the temperature of the light source 400 detected by the temperature detection section 114 provided in each of the light sources 400, whereby the current value can be controlled appropriately in accordance with the temperature of the light source 400.

In the projector 1 according to the present embodiment, since the temperature detection section 114 is mounted on the circuit board 110 on which the light emitter 120 is mounted, it is possible to detect the temperature with high accuracy at a position close to the light emitter 120, and it becomes possible to perform the appropriate control of the current value with higher accuracy.

In the projector 1 according to the present embodiment, the temperature detection section 114 is disposed on the opposite side of the pad section 115 with the light emitter 120 interposed therebetween, whereby the influence of heat generated in the pad section 115 can be suppressed.

In the projector 1 according to the present embodiment, the surface position where the temperature detection section 114 is exposed is flush with the light emitting surface of the light emitting section 120a, whereby the temperature can be detected under the same conditions as those for the light emitting section 120a, and the temperature of the light emitter 120 can be detected with higher accuracy.

In the projector 1 according to the present embodiment, since the temperature detection section 114 is disposed in the range opposed to the incident end surface of the light guide element 40, it is possible to detect the temperature with high accuracy according to the temperature rise of the light emitter 120.

In the projector 1 according to the present embodiment, since the drive of the driver element 84 is controlled in conjunction with the first cooling device 31 and the second cooling device 32 in accordance with the temperature of the light source 400 detected by the temperature detection section 114, even if the air blowing amounts of all of the first fan 31A, the second fan 31B, and the third fan 32A are increased, and when the temperatures detected by the temperature detection section 114 do not fall within the predetermined range, it is possible to appropriately control the light amount of the light emitted from the light emitter 120.

In the projector 1 according to the present embodiment, by disposing the third heat exchangers 113A at a position closer to the third fan 32A than the second heat exchangers 112B in the second cooling flow path 62, whereby the third light emitter 123, which emits red light, can be cooled via the third heat exchangers 113A by the air that is before the temperature thereof rises due to heat exchange with the second heat exchangers 112B, whereby the life of the third light emitter 123 can be increased.

In the projector 1 according to the present embodiment, the single third fan 32A is disposed in the second cooling flow path 62, which releases a small amount of heat, and the two fans of the first fan 31A and the second fan 31B are disposed in the first cooling flow path 61, which releases a large amount of heat, whereby the first cooling flow path 61 and the second cooling flow path 62 can be effectively cooled in accordance with the amount of heat released.

In the projector 1 according to the present embodiment, the second light source 402, which emits green light, is directly cooled by heat exchange with the air flowing through the first cooling flow path 61, and the second heat exchangers 112B are indirectly cooled via the heat pipe 112A by heat exchange with the air flowing through the second cooling flow path 62. Therefore, in the projector 1 according to the present embodiment, the second light source 402 of green light, to which the human eye is most sensitive and which has a large driving amount, can be cooled more effectively using both the first cooling device 31 and the second cooling device 32.

In the projector 1 according to the present embodiment, since the end portions on the +Y side of the second heat exchangers 112B are positioned on the +Y side of the -Y side end portion of the second circuit board 112, the second heat exchangers 112B can be disposed on the +Y side compared to the case where the second heat exchangers 112B are disposed in contact with the -Y side of the second circuit board 112, whereby the projector main body 3 can be reduced in size in the Y direction.

In the projector 1 according to the present embodiment, it has the branch duct 34 that forms the plurality of branch paths 37 for branching the air from the air blowing port 31C and leading the air to the opening section 38A and the opening sections 38B, 38C, and 38D, the cooling target can be cooled more effectively by setting the positions of the opening sections 38B, 38C, and 38D according to the cooling target.

The SoC 82 directly controls the fourth light source 28 mounted on the auxiliary board 90. The fourth light source 28 is controlled by pulse width modulation control. Since the SoC 82 directly controls the fourth light source 28 without interposing a driver or the like, the number of components can be reduced.

The SoC 82 is connected to the microcontroller 24 of the connection board 93, and indirectly controls the touch sensor 22 via the microcontroller 24.

That is, in the present embodiment, the SoC 82 directly or indirectly controls the LED 13, the fourth light source 28, and the touch sensor 22. In this way, since the SoC 82 controls a plurality of components such as the indicator 27 and the LED driver 12 together, the number of components can be reduced as compared with a case where circuits are separately provided.

The main board 81 includes the power supply circuit 83. The power supply circuit 83 is supplied with power via the AC adapter 20 and the power supply wiring 18. The power supply circuit 83 supplies electricity from the AC adapter 20 to the SoC 82, the LED 13, the fourth light sources 28, the LED driver 12, various elements, and the like. Since the power supply circuit 83 is configured to supply electricity to a plurality of supply destinations, the circuit configuration can be simplified and the number of components can be reduced.

In the present embodiment, since the main board 81, the illumination board 11, the auxiliary board 90, and the connection board 93 are provided separately from each other, it is possible to disperse the heat generated in each board and suppress the influence on the projector 1.

### 6. Other Embodiments

The above described embodiments are desired embodiments of the present disclosure. However, the present disclosure is not limited to the above described embodiment, and various modifications can be made without departing from the gist of the present disclosure.

For example, in the above described embodiment, the configuration in which the temperature detection section 114 is disposed within the range opposing the incident end surface of the light guide element 40 has been exemplified, but the present disclosure is not limited to this configuration. The present disclosure is applicable to a configuration in which the temperature detection section 114 is disposed outside the range opposing the incident end surface of the light guide element 40.

For example, in the embodiment described above, the projector main body 3 has the rectangular shaped notch 14 in the bottom view of the projector main body 3. However, the shape of the notch is not particularly limited, and may be an oval shaped notch or a notch having a shape in which a part thereof is widened.

For example, when the number of LEDs as the second light source is small, the SoC may directly perform control without providing the LED driver.

In the embodiment described above, the AC adapter is used as the power supply adapter, and the electricity is supplied to the projector 1 by the AC adapter terminal provided on the base. However, the power supply adapter is not limited to the AC adapter, and an existing power adapter can be used. The power supply terminal can be changed depending on the power supply adapter to be used.

In the above described embodiment, the touch sensor 22 is provided with the oval shaped opening 22a. However, the touch sensor may be provided with a recess instead of the opening. In the case where the recess is provided in the touch sensor, the excess solder flows into the recess, and thus, the solder can be prevented from contaminating the touch sensor and affecting the touch sensor, thereby preventing a decrease in sensitivity.

The bonding between the touch sensor and the sensor wiring is not limited to solder, and an existing conductive bonding material can be used.

### 7. Summary of Present Disclosure

Hereinafter, a summary of the present disclosure is supplementary noted.

Supplementary note 1 A projector includes a plurality of light sources; a temperature detection section and a heat exchanger provided in each of the plurality of light sources; a housing configured to house the plurality of light sources and the heat exchangers; a partition section configured to partition an internal space of the housing into a first cooling flow path and a second cooling flow path; a first cooling device configured to cool the first cooling flow path; a second cooling device configured to cool the second cooling flow path; a drive element configured to control drive of the plurality of light sources; and an integrated circuit element that is configured to drive the first cooling device and the second cooling device and that is configured to control the drive element, wherein at least one of the heat exchangers is disposed in each of the first cooling flow path and the second cooling flow path and the integrated circuit element is configured to control drive of each of the first cooling device and the second cooling device according to temperature of the light source detected by the temperature detection section.

According to this, it is possible to appropriately control the current value according to the temperature of the light source detected by the temperature detection section.

Supplementary note 2 The projector according to supplementary note 1, wherein the light source has a circuit board on which a light emitter is mounted and the temperature detection section is mounted on the circuit board.

According to this, the temperature can be detected with high accuracy at a position close to the light emitter, and the current value can be appropriately controlled with higher accuracy.

Supplementary note 3 The projector according to supplementary note 2, wherein the circuit board has a pad section electrically connected to the integrated circuit element and the temperature detection section is disposed on a side opposite to the pad section with the light emitter interposed therebetween.

According to this, the influence of heat generated in the pad section can be suppressed.

Supplementary note 4 The projector according to supplementary note 2 or 3, wherein a surface position of the temperature detection section is flush with a light emitting surface of the light emitter.

According to this, the temperature can be detected under the same conditions as the light emitting section, and the temperature of the light emitter can be detected more accurately.

Supplementary note 5 The projector according to any one of supplementary note 2 to supplementary note 4, further including a light guide element configured to guide light from the light emitter, wherein the temperature detection section is disposed in a range that is in the circuit board and that faces an incident end surface of the light guide element.

According to this, the temperature detection section can detect the temperature with high accuracy according to the temperature rise of the light emitter.

Supplementary note 6 The projector according to any one of supplementary note 2 to supplementary note 5, wherein the integrated circuit element is configured to control drive of the drive element together with the drive of the first cooling device and the second cooling device according to the temperature of the light source detected by the temperature detection section.

According to this, even when the air blowing amounts of the first cooling device and the second cooling device are increased, the light amount control of the light emitted from the light source can be appropriately performed even when the temperature detected by the temperature detection section does not fall within the predetermined range.

Supplementary note 7 The projector according to any one of supplementary note 2 to supplementary note 6, wherein the light source includes a first light source configured to emit blue light, a second light source configured to emit green light, and a third light source configured to emit red light, the heat exchangers include a first heat exchanger provided in the first light source, a second heat exchanger provided in the second light source, and a third heat exchanger provided in the third light source, the first light source, the second light source, the third light source, and the first heat exchanger are disposed in the first cooling flow path, and the second heat exchanger and the third heat exchanger are disposed in the second cooling flow path.

According to this, the first light source, the second light source, the third light source, and the first heat exchanger disposed in the first cooling flow path can be cooled using the first cooling device, and the second heat exchanger and the third heat exchanger disposed in the second cooling flow path can be cooled using the second cooling device.

Supplementary note 8 The projector according to supplementary note 7, wherein the second cooling device is disposed on one side of the second cooling flow path that extends in a first direction, which is orthogonal to a height direction of the housing, the second heat exchanger and the third heat exchanger are disposed on an other side in the first direction with respect to the second cooling device, and the third heat exchanger is disposed on the one side in the first direction with respect to the second heat exchanger.

According to this, the third light source that emits red light can be cooled via the third heat exchanger by the air before the temperature rises due to the heat exchange with the second heat exchanger, and the life of the third light source can be extended.

Supplementary note 9 The projector according to supplementary note 8, further including a heat pipe that is disposed across the first cooling flow path and the second cooling flow path and that is in contact with the second light source and the second heat exchanger.

According to this, the second light source can be directly cooled by the second cooling device, and can also be indirectly cooled via the second heat exchanger and the heat pipe.

Supplementary note 10 The projector according to supplementary note 9, wherein the heat pipe is in contact with an end portion of the second light source on the other side in the first direction and an end portion of the second heat exchanger on the one side in the first direction is positioned on the one side in the first direction with respect to the end portion of the second light source on the other side in the first direction as viewed from the height direction of the housing.

According to this, the projector can be downsized in the first direction.

What is claimed is:

1. A projector comprising:
a plurality of light sources;
a temperature detection section and a heat exchanger provided in each of the plurality of light sources;
a housing configured to house the plurality of light sources and the heat exchangers;
a partition section configured to partition an internal space of the housing into a first cooling flow path and a second cooling flow path;
a first cooling device configured to cool the first cooling flow path;
a second cooling device configured to cool the second cooling flow path;
a drive element configured to control drive of the plurality of light sources; and
an integrated circuit element that is configured to drive the first cooling device and the second cooling device and that is configured to control the drive element, wherein
at least one of the heat exchangers is disposed in each of the first cooling flow path and the second cooling flow path and
the integrated circuit element is configured to control drive of each of the first cooling device and the second cooling device according to temperature of the light source detected by the temperature detection section.

2. The projector according to claim 1, wherein
the light source has a circuit board on which a light emitter is mounted and
the temperature detection section is mounted on the circuit board.

3. The projector according to claim 2, wherein
the circuit board has a pad section electrically connected to the integrated circuit element and
the temperature detection section is disposed on a side opposite to the pad section with the light emitter interposed therebetween.

4. The projector according to claim 2, wherein
a surface position of the temperature detection section is flush with a light emitting surface of the light emitter.

5. The projector according to claim 2, further comprising:
a light guide element configured to guide light from the light emitter, wherein
the temperature detection section is disposed in a range that is in the circuit board and that faces an incident end surface of the light guide element.

6. The projector according to claim 1, wherein
the integrated circuit element is configured to control drive of the drive element together with the drive of the first cooling device and the second cooling device according to the temperature of the light source detected by the temperature detection section.

7. The projector according to claim 1, wherein
the light source includes a first light source configured to emit blue light, a second light source configured to emit green light, and a third light source configured to emit red light,
the heat exchangers include a first heat exchanger provided in the first light source, a second heat exchanger provided in the second light source, and a third heat exchanger provided in the third light source,
the first light source, the second light source, the third light source, and the first heat exchanger are disposed in the first cooling flow path, and
the second heat exchanger and the third heat exchanger are disposed in the second cooling flow path.

8. The projector according to claim 7, wherein
the second cooling device is disposed on one side of the second cooling flow path that extends in a first direction, which is orthogonal to a height direction of the housing,
the second heat exchanger and the third heat exchanger are disposed on an other side in the first direction with respect to the second cooling device, and
the third heat exchanger is disposed on the one side in the first direction with respect to the second heat exchanger.

9. The projector according to claim 8, further comprising:
a heat pipe that is disposed across the first cooling flow path and the second cooling flow path and that is in contact with the second light source and the second heat exchanger.

10. The projector according to claim 9, wherein
the heat pipe is in contact with an end portion of the second light source on the other side in the first direction and
an end portion of the second heat exchanger on the one side in the first direction is positioned on the one side in the first direction with respect to the end portion of the second light source on the other side in the first direction as viewed from the height direction of the housing.
